(19) United States
(12) Patent Application Publication
(10) Pub. No.: US 2025/0036135 A1
(43) Pub. Date: Jan. 30, 2025

(54) SYSTEM AND METHOD FOR AUTONOMOUS ROBOTIC MAP GENERATION FOR TARGETED RESOLUTION AND LOCAL ACCURACY

(71) Applicants: University of Virginia Patent Foundation, Charlottesville, VA (US); THK Co., Ltd., Tokyo (JP)

(72) Inventors: Tomonari Furukawa, Earlysville, VA (US); Jun Kawasaki, Tokyo (JP); Masaki Shibuya, Tokyo (JP)

(21) Appl. No.: 18/766,153

(22) Filed: Jul. 8, 2024

Related U.S. Application Data
(60) Provisional application No. 63/512,573, filed on Jul. 7, 2023.

(51) Int. Cl. G05D 1/246; G05D 111/10; G06T 7/521

(52) U.S. Cl. CPC G05D 1/2465; G06T 7/521; G05D 2111/17; G06T 2207/10024; G06T 2207/10028

(57) ABSTRACT

Various examples are provided related to generating a map of an environment. In one example, a method includes obtaining a coarse global mapping of an environmental space; determining a robotic traversal path within the environmental space using the coarse global mapping, the robotic traversal path maintaining a targeted distance to a nearest structure within the environmental space; initiating traversal of a robot along the determined robotic traversal path, the robot obtaining depth sensor measurements of the nearest structure during traversal along the determined robotic traversal path; and refining the robotic traversal path during traversal by the robot along the determined robotic traversal path based upon the depth sensor measurements, where the robotic traversal path is refined online to achieve targeted resolution and local accuracy of the depth sensor measurements. A refined map of the environmental space can be generated using the depth sensor measurements.

### CROSS REFERENCE TO RELATED APPLICATIONS

This application claims priority to, and the benefit of, U.S. provisional application entitled “System and Method for Autonomous Robotic Map Refinement for Targeted Resolution and Local Accuracy” having Ser. No. 63/512,573, filed Jul. 7, 2023, which is hereby incorporated by reference in its entirety.

### STATEMENT REGARDING FEDERALLY SPONSORED RESEARCH OR DEVELOPMENT

This invention was made with government support under Grant No. N00014-20-1-2468, awarded by the Department of Defense. The government has certain rights in the invention.

### BACKGROUND

Mapping of unknown environments is a fundamental task of engineering, which sees various valuable applications. They include the three-dimensional (3D) data storage, the monitoring, and the inspection of existing structures and terrains. Maps can even be developed online for robots to navigate and complete their missions, such as search and rescue (SAR), in unknown environments. Robotic mapping is becoming ever more important due to the extensive potential that can be derived from high-precision results. If the mobile robot can develop a 3D map, it would reduce both time and human workload. If the map is accurate, the quality of work could also be improved.

### SUMMARY

Aspects of the present disclosure are related to generating a map of an environment. In one aspect, among others, a method for generating a map of an environment comprises obtaining a coarse global mapping of an environmental space; determining a robotic traversal path within the environmental space based at least in part upon the coarse global mapping, the robotic traversal path maintaining a targeted distance to a nearest structure within the environmental space; initiating traversal of a robot along the determined robotic traversal path, the robot configured to obtain depth sensor measurements of the nearest structure during traversal along the determined robotic traversal path; and refining the robotic traversal path during traversal by the robot along the determined robotic traversal path based upon the depth sensor measurements, where the robotic traversal path is refined online to achieve targeted resolution and local accuracy of the depth sensor measurements.

In one or more aspects, the method can comprise generating a refined map of the environmental space based at least in part upon the depth sensor measurements. The coarse global mapping can be a three-dimensional (3D) globally accurate mapping obtained by the robot. The coarse global mapping can be obtained via a LIDAR scan. The targeted distance can be associated with the targeted resolution and local accuracy. The method can comprise determining the targeted distance such that a sum of a difference between a predicted resolution and the targeted resolution and a difference between a predicted local accuracy and the targeted local accuracy is smallest.

In various aspects, the robotic traversal path can be a three-dimensional (3D) robotic traversal path within the environmental space. Determining the robotic traversal path within the environmental space can comprise determining an occupancy grid map (OGM), in which each grid has information indicating whether corresponding space is occupied or not, at a plurality of heights in the environmental space; determining an unoccupancy distance map (UDM), in which each pixel has a distance to a nearest occupied grid, for each OGM of the plurality of heights; determining a two-dimensional (2D) path at each of the plurality of heights based upon the targeted distance; and connecting the 2D paths to produce the 3D robotic traversal path. Determining the 2D path at each of the plurality of heights can comprise selecting a pixel in UDM having the targeted distance; and connecting the selected pixels. The 2D paths can be connected for robot traversal of the 3D path in a single loop.

In some aspects, refining the robotic traversal path can be based upon pixel density of the depth sensor measurements. The depth sensor measurements can be obtained via RGB-D camera measurements. Refining the robotic traversal path can comprise determining an incremental motion of the robot so as to minimize a difference between a desired robot pose at a next time step and a current robot pose under a constraint that a predicted pixel density is the desired pixel density and a predicted local accuracy is the desired local accuracy. The coarse global mapping can comprise a globally accurate point cloud and refining the robotic traversal path comprises refining the globally accurate point cloud by registering point cloud data of the depth sensor measurements to the globally accurate point cloud.

In another aspect, a system for generating a map of an environment comprises a robot configured to obtain depth sensor measurements; and at least one computing device in communication with the robot, the at least one computing device configured to: determine a robotic traversal path within an environmental space based at least in part upon a coarse global mapping of the environmental space, the robotic traversal path maintaining a targeted distance to a nearest structure within the environmental space; initiate traversal of the robot along the determined robotic traversal path, the robot configured to obtain depth sensor measurements of the nearest structure during traversal along the determined robotic traversal path; and refine the robotic traversal path during traversal by the robot along the determined robotic traversal path based upon the depth sensor measurements, where the robotic traversal path is refined online to achieve targeted resolution and local accuracy of the depth sensor measurements. In one or more aspects, the coarse global mapping can be a three-dimensional (3D) globally accurate mapping obtained by the robot. The robot can obtain the coarse global mapping via a LIDAR scan.

In various aspects, the robotic traversal path can be a three-dimensional (3D) robotic traversal path within the environmental space. Determining, by the at least one computing device, the robotic traversal path within the environmental space can comprise: determining an occupancy grid map (OGM), in which each grid has information indicating whether corresponding space is occupied or not, at a plurality of heights in the environmental space; determining an unoccupancy distance map (UDM), in which each pixel has a distance to a nearest occupied grid, for each OGM of the plurality of heights; determining a two-dimensional (2D) path at each of the plurality of heights based upon the targeted distance; and connecting the 2D paths to produce the 3D robotic traversal path. The 2D paths can be connected for robot traversal of the 3D path in a single loop. The robotic traversal path can be refined by the at least one computing device based upon pixel density of the depth sensor measurements obtained by the robot. The robot can comprise an RGB-D camera configured to obtain the depth sensor measurements. The coarse global mapping can comprise a globally accurate point cloud and the at least one computing device generates a refined map of the environmental space by registering point cloud data of the depth sensor measurements to the globally accurate point cloud.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates examples of different mapping pipelines used to create a map of an unknown environment, in accordance with various embodiments of the present disclosure.

FIG. 2 illustrates examples of images and poses being used as inputs for NeRF to generate a 3D rendering of a captured object, in accordance with various embodiments of the present disclosure.

FIG. 3 illustrates an example of a multistage approach for map generation and refinement using a coarse LiDAR map as an input, in accordance with various embodiments of the present disclosure.

FIG. 4 illustrates examples of an occupancy grid map (OGM) and unoccupancy distance map (UDM), in accordance with various embodiments of the present disclosure.

FIG. 5 illustrates an example of pixels selected to compose an offline path, in accordance with various embodiments of the present disclosure.

FIG. 6 illustrates an example of a 3D offline path of two layers, in accordance with various embodiments of the present disclosure.

FIG. 7 illustrates an example of a multistage approach for map generation and refinement including development of a coarse globally accurate 3D map, in accordance with various embodiments of the present disclosure.

FIG. 8 illustrates an example of a depth sensor making an observation on a planar wall of an indoor environment, in accordance with various embodiments of the present disclosure.

FIG. 9 illustrates an example of a unit viewing area for a sensor at a given distance, given by rotating the field of view and inscribing a square into the union of all the fields of view, in accordance with various embodiments of the present disclosure.

FIG. 10 illustrates an example of a resulting 3D offline path of a room with two horizontal layers and three vertical layers, in accordance with various embodiments of the present disclosure.

FIG. 11 is a table illustrating examples of parameters used for path planning of Step 1, in accordance with various embodiments of the present disclosure.

FIG. 12 illustrates examples of synthetic maps used for validation, in accordance with various embodiments of the present disclosure.

FIG. 13 illustrates box plots of computational time with respect to map size and object number in the environment, in accordance with various embodiments of the present disclosure.

FIGS. 14A and 14B are tables illustrating examples of parameters of the validation, in accordance with various embodiments of the present disclosure.

FIG. 15 includes images illustrating examples of known structures for testing the resolution and local accuracy, in accordance with various embodiments of the present disclosure.

FIGS. 16-19 illustrate histograms of local accuracy and resolution of the controlled environments, in accordance with various embodiments of the present disclosure.

FIGS. 20A and 20B illustrate examples of UGV, environment and parameters for a real-world experiment, in accordance with various embodiments of the present disclosure.

FIGS. 21A-21D illustrate examples of experimental results of the real-world experiment, in accordance with various embodiments of the present disclosure.

FIGS. 22A and 22B illustrate examples of UGV, environment and parameters for another real-world experiment, in accordance with various embodiments of the present disclosure.

FIGS. 23A-231 illustrate examples of experimental results of other real-world experiments, in accordance with various embodiments of the present disclosure

FIG. 24 is a schematic block diagram illustrating an example of a system employed for generating a map of an environment, in accordance with various embodiments of the present disclosure.

### DETAILED DESCRIPTION

Disclosed herein are various examples related to generating a map of an environment. Autonomous robotic map refinement can be used to provide targeted resolution and local accuracy. To create a map, the target qualities are first defined to optimize the process. Typically, the accuracy, resolution, and size of the completed map are targeted to a reasonable range of values. To significantly improve the mapping efforts, the resultant map should aim to have high quality metrics at both global and local levels. Reference will now be made in detail to the description of the embodiments as illustrated in the drawings, wherein like reference numbers indicate like parts throughout the several views.

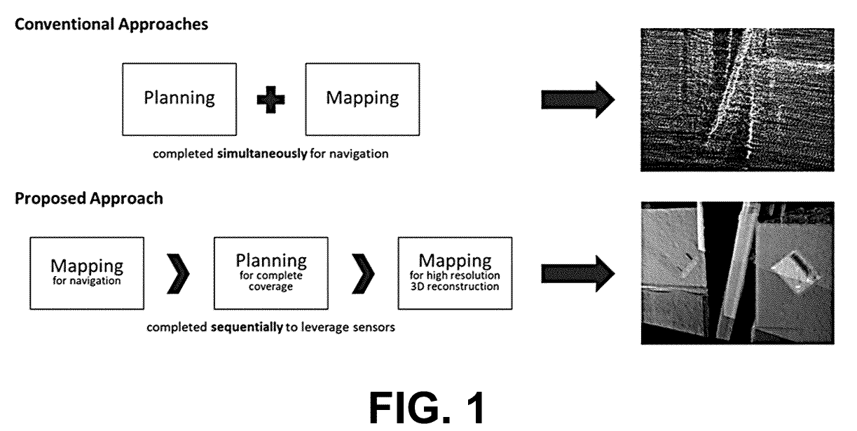

While different mapping pipelines may be used to create a map of an unknown environment, conventional approaches currently plan the path of the robot and map the environment at the same time as shown in FIG. 1. However, a single approach cannot target exceptional accuracy, resolution, and size all at the same time, due to the limitations of current sensor technology, which usually has a trade-off between these metrics. These approaches are not able to leverage the strengths of the different sensors and can only target one metric within a reasonable range, typically global accuracy. Past work on robotic mapping can be broadly classified into two approaches.

The first is online robotic mapping techniques, such as simultaneous localization and mapping (SLAM) and its variants, where a robot entering an unknown environment iteratively builds up a map while also computing a continuous estimate of the robot location. This is a computationally costly process, since many SLAM algorithms will take advantage of both visual and internal sensors by fusing the data. Therefore, SLAM algorithms typically focus on representing the environment in the most compact way in order to reduce the computational costs. Maps are created primarily for successful robot navigation, where global accuracy is the major focus not the local resolution and accuracy. Alternatively, information from the sensors is simply used to estimate relative pose between robot poses to generate the estimate of the robot motion. All the observations gathered from the sensors can then be used to assemble a map of the environment using the estimated robot poses. In general, SLAM algorithms use information gathered by visiting previously traversed regions for “loop closure” and maintain the accuracy of global robot location. Maps are created primarily for successful robot navigation; their accuracy is typically not a major focus.

While these approaches are well developed and are suitable for creating a map, there remains a gap between the focus of SLAM and creating a high-precision map. Since the objective of SLAM is to build a map of a completely unknown environment, the technique requires no prior knowledge, but the resultant map is typically sparse or locally inaccurate. To shift the quality of SLAM towards high-precision mapping, the environment should be explored thoroughly while considering the optimal viewing points. This exploration can be completed by using the next-best view approach for determining where optimal sensor observations are located. The unknown environment can be explored by analyzing frontier regions and predicted occlusions to determine the most optimal viewing location. The results can be further improved by representing the scene as surfaces and revisiting the incomplete areas. New techniques have been developed that make use of fixed manipulators and determining the best viewing positions inside the workspace to observe the entire environment. The main issue with these techniques is that they rely on frontier identification and therefore do not know the whole environment during planning. This leads to areas being observed with different observation qualities, which is not sufficient to generate a consistent map of the scene. By coarsely exploring the environment and then navigating, the environment can be explored completely and uniformly with high accuracy.

In the second, the mapping approaches are accomplished using offline techniques. Structure from Motion (SfM) techniques use information from a sequence of images to build up a representation of the environment. Typically, a 3D point cloud that corresponds to visually identified features of occupied regions of the environment is generated (e.g., by projecting points from the image frame into Euclidean space). To maximize the map accuracy, the SfM deploys bundle adjustment (BA), which globally minimizes the reprojection error. Thus, the advantage of the SfM is the global accuracy of the environment representation as the 3D point cloud is computed offline through global optimization. The offline optimization allows larger environments to be accurately represented with 3D point clouds by making use of aerial images and videos. Throughout the disclosure, high global accuracy is defined as having minimal or negligible errors compared to the ground truth relative to the scale of the entire map.

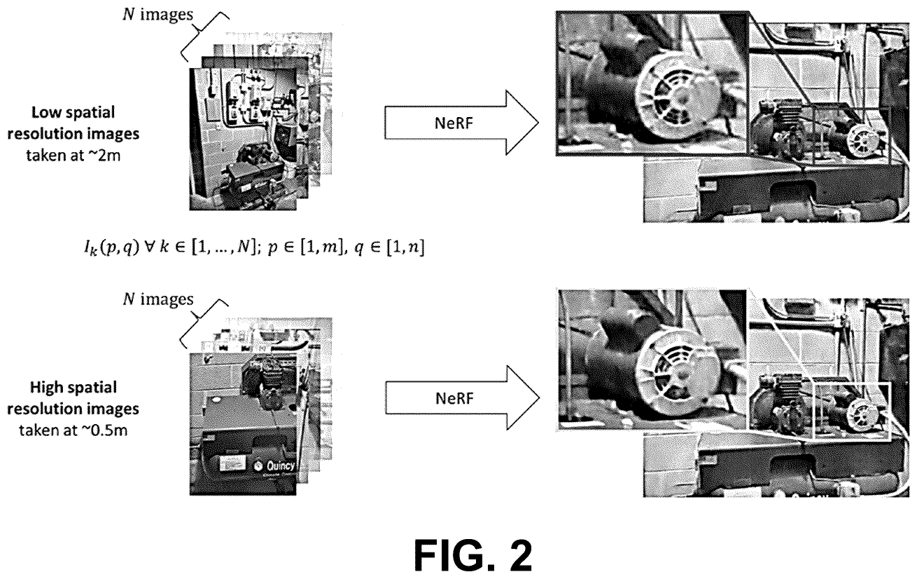

Neural radiance fields (NeRF) is an example of an offline approach for generating high-resolution 3D viewpoints for an object, given a set of images and camera poses. The key focus of NeRF is to efficiently represent the scene with implicit functions along viewing rays by outputting a density function relating to the lengths of the rays with colors associated with the position along a given ray. One of the practical issues with NeRF is the reliance on poses for each image which was originally computed using SfM, but new methods can learn the camera extrinsics while creating the 3D model. Regardless of the methods for finding the camera extrinsics, the performance is hindered when high resolution is the goal, and the images must be captured near the surface of interest. If the room can be sampled with a hyper-resolution that is not conventionally achieved with SfM, the 3D reconstruction results can be greatly improved, as seen in FIG. 2. The images and poses in FIG. 2 are used as inputs for NeRF to generate a 3D rendering of the captured object. The standard set of images have a lower resolution in a unit area as compared to the images taken closer to the surface. The differences in results are not too noticeable from the far viewpoint, but the differences can be seen from the close viewpoint. Thus, the advantage of offline techniques is the global accuracy of the environment representation is unaffected by the environment size, as the 3D point cloud is computed offline through global optimization.

While both approaches are well developed and are suitable for exploring an unknown environment and generating a map, they mainly focus on global accuracy and do not target resolution and local accuracy of the map, which is the topic of this disclosure. Having only the global accuracy pursued, we often see surfaces with coarse measurement or unexplored surfaces. In either case, there are insufficient resolution and local accuracy to identify the area. Recent effort on actively directing the robot while the environment is being explored, which is often referred to as Active SLAM, could reduce unexplored spaces. However, the primary target remains to be the global accuracy since the metrics used to direct robot motion are typically with the desire to locate the robot with successful loop closure. Robot navigation and environment mapping guaranteeing a targeted resolution and local accuracy have not been discussed in the past.

The framework proposed in this disclosure divides the problem into three distinct stages as shown in FIG. 1, allowing the strengths of different sensors to be leveraged to target multiple metrics. The multistage approach is presented to refine the map of an environment autonomously by a mobile robot, which was originally constructed by a conventional technique such as SLAM and SfM. The refinement is to satisfy the targeted resolution and local accuracy. A coarse but globally accurate map can be constructed by a conventional technique, such as SLAM (or SfM), by exploring an unknown environment with minimum motion. This provides a globally accurate skeleton of the environment to be used for path planning and pose estimation in the following steps. This may be considered a preliminary step. Given the coarse but globally accurate map, the first step (Step 1) plans a robot path which achieves the targeted distance. By having the resolution and local accuracy formulated in association with distance to the nearest structure, any point on the path can be planned to have the targeted resolution and local accuracy. An unoccupancy distance map (UDM) and a reduced order travelling salesman problem (TSP) technique are newly proposed to solve this class of problem. The targeted distance approximately guarantees the targeted metrics to control the quality of the resulting map. In the second step (Step 2), a path replanning technique can direct the robot online to achieve the targeted resolution and local accuracy precisely. By replanning the path during the final step, the robot can autonomously record the data with the desired quality metrics. The strength of the proposed framework is its ability to autonomously create a high-quality map without compromising the global and local quality of the map. As the 3D path planning problem in Step 1 is reduced into a set of two-dimensional (2D) and one-dimensional (1D) problems, the proposed approach can refine the map with a high success rate.

Next, current mapping efforts and the need for map refinement are described, followed by the multistage approach proposed for map refinement. Experimental validation including parametric studies is presented.

### Mapping of an Unknown Environment and Need for Map Refinement

Mapping of an Unknown Environment. The robot maps an unknown environment using sensors that observe a local depth field and motion sensors that measure changes in the robot pose. Sensors can include a combination of, e.g., visual sensors, inertial sensors, encoders, etc. A typical configuration can include a visual sensor that observes a local depth field and inertial sensors that measure changes in the robot pose. Given information on the initial pose of the robot and measurements from the sensors along the robot trajectory, pose of the robot can be estimated and the mapping can output a two-dimensional (2D) map and/or 3D point cloud that represents the environment to a desired accuracy and resolution.

At a conceptual level, the problem of mapping an environment purely from information acquired by a set of sensors on-board a robot can be mathematically defined as follows. Let knowledge on the initial pose of the robot be \hat{X}₀^{r}. Information acquired by the depth sensor at time step k and the robot motion from k−1 to k measured by the motion sensor are ^{r}Iₖ and ^{r}Z_{k,k-1}^{m} respectively. Given the estimate of the robot pose at k−1 by \hat{X}ₖ₋₁^{r}, the principle of the online mapping problem can be defined as updating the pose \hat{X}ₖ^{r} with the observations ^{r}Iₖ and ^{r}Z_{k,k-}^{m}:

$${\hat{x}}_{k}^{r} := {\hat{x}}_{k}^{r} + {W}_{k}^{I} [ {}^{r} {I}_{k} - {}^{r} {h}_{I} ( {\hat{x}}_{k}^{r} ) ] + {W}_{k}^{m} [ {}^{r} {z}_{k , k - 1}^{m} - {}^{r} {h}_{m} ( {\hat{x}}_{k}^{r} , {\hat{x}}_{k - 1}^{r} ) ] \qquad ( 1 )$$

where ^{r}h_{I}(\hat{x}ₖ^{r}and ^{r}hₘ(e,cir x_{k,}^{r}\hat{x}ₖ₋₁^{r}) are the sensor models associating the pose with the sensor output. Wₖ^{I} and Wₖ^{m} are the matrices that transform the sensor output into the pose, and :=substitutes the right-hand terms into the left-hand variable. Once the pose \hat{x}ₖ^{r} has been identified and finalized over the time steps, the registration of the observations ^{r}Iₖ completes the mapping process. Registration can be performed by, e.g., appending the incoming point cloud straight to the map or by a executing the iterative closest point (ICP) algorithm, as defined by:

$$( R , t ) = {arg min}_{R , t} {\sum }_{( i , j ) ∈ 𝒞} {‖ {I}_{j} - R {I}_{k , j} - t ‖}_{2}$$

where C is the set of corresponding points; R is the rotation matrix; and t is the translation vector that transforms the incoming point cloud, Iₖ, to the map point cloud, I. BA through global optimization is typically the last step to adjust \hat{x}ₖ and Iₖ to increase the global accuracy by minimizing the reprojection error. The resulting point cloud which represents the map of the environment is given by I={Iₖ, ∀k}. The BA through global optimization is typically the last step to adjust \hat{x}ₖ^{r} and ^{r}Iₖ. The resulting point cloud which represents the map of the environment is given by ^{r}I={^{r}I_{k|∀k}.}

Need for Map Refinement. While the map can be created, the quality of the map is insufficient in two cases. The first case is yielded by the failure of coverage of surfaces by the depth sensor measurements ^{r}Iₖ, ∀k. Since the 3D environment could be considerably complex, the failure occurs even if a sophisticated Active SLAM technique is deployed. In the second case, there may exist a depth sensor measurement ^{r}Iₖ, ∃k which does not satisfy the targeted resolution. Since the low resolution is a result of measurement with distance, the local depth measurement may not also be accurate. The map quality is insufficient in both the cases because the map becomes coarse. If it is to be used to recognize the environment, the map should be finely represented.

The map created for global accuracy is generally poor in resolution and local accuracy since both cannot be achieved simultaneously. If the global accuracy is pursued, resolution and local accuracy are lost to maintain global accuracy. This indicates that the map refinement should be conducted only after a coarse map has been built in the preceding step (“Step 0”). The map refinement approach proposed in this disclosure will next be presented.

### Robotic Map Refinement

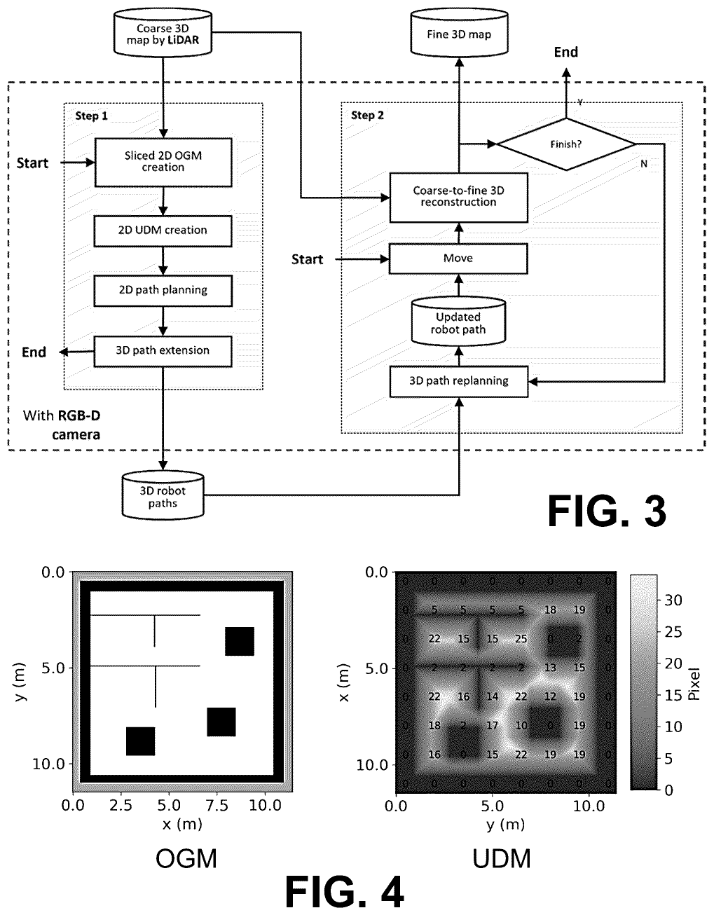

FIG. 3 shows a schematic diagram of an example of the proposed robotic map refinement approach. The proposed approach uses the coarse global map developed by conventional mapping with minimum motion as an input and focuses on refining the map to achieve the targeted resolution and local accuracy by an autonomous robot. Minimum motion such as, e.g., a single loop around the environment can be used during coarse mapping to maintain the global accuracy by reducing the distance estimated during SLAM or SfM. It is to be noted that the depth sensor of the proposed approach can be an RGBD camera for its high areal resolution whereas that of the coarse global mapping in the preceding step can be a LiDAR for its high depth accuracy. High depth accuracy is needed in preceding coarse global mapping because the robot may be away from its surrounding structures to achieve global accuracy while the robot needs to be close to its surrounding structures in the proposed approach to achieve the targeted resolution and local accuracy.

The proposed approach comprises two steps. The first step, Step 1, plans a 3D path of the robot offline, which keeps the desired distance to the nearest structure of the environment and approximately guarantees the minimum desired resolution and accuracy. Since the indoor environment is most often designed with horizontally stretched space, the coarse global map can first be sliced into multiple horizontal 2D planes each with a different height, and an occupancy grid map (OGM) can be created for each 2D plane. The proposed approach can then create a UDM for each OGM and identify pixels of the UDM image that have the desired distance to the nearest structure. The pixels of each layer can be connected using a reduced-order TSP technique which results in the 2D path of the robot of the layer. In the final process of Step 1, the 2D paths are connected so that the robot covers the 3D space in a single trip.

In Step 2, a map refining technique replans a path and updates a map with RGB-D camera measurements online. While the offline path is concerned only with the distance to the nearest structure, the path replanned online navigates the robot such that the final map satisfies the targeted resolution and local accuracy. The robot moves not only to refine the map but also explore areas that were not identified in coarse global mapping. Once the robot has moved, the RGB-D camera measurements are registered to improve the map quality from coarse to fine. The process can continue until the robot completes the map refinement.

Offline 3D Path Planning. Step 1 of the proposed approach aims for the targeted resolution and depth accuracy by planning the path of the robot so that its corresponding targeted distance to the nearest structure of the environment is maintained. To ensure that autonomous path planning does not fail in a complex 3D environment and being aware that the indoor space is stretched horizontally, the robot can plan to revisit the entire 3D space by moving horizontally at different heights. Let the i-th grid pⁱ=[xⁱ, yⁱ]^{T} of the 2D OGM created by slicing the coarse global 3D map of the conventional mapping at some height be:

$${m}_{OGM} ( {p}^{i} ) = \{ \begin{matrix}0 & occupied \\ 1 / 2 & unexplored \\ 1 & unoccupied\end{matrix} \qquad ( 2 )$$

where m_{OGM}(⋅) is an occupancy grid mapping operator. The OGM conventionally outputs the values of 0, ½ and 1 for occupied, unexplored and unoccupied grids respectively. The proposed approach re-expresses the OGM as the Euclidean UDM towards planning a 3D path offline and returns an unoccupancy distance as:

$${m}_{UDM} ( {p}^{i} ) = \{ \begin{matrix}0 & occupied ⋃ unexplored \\ {d}_{u}^{i} & unoccupied\end{matrix} \qquad ( 3 )$$

where m_{UDM}(⋅) is a revised version of the OGM operator that outputs the distance of the grid from the nearest occupied grid. The distance in the UDM is 0 when the grid is “unexplored” in addition to “occupied.” The state of “unexplored” is treated equally to the “occupied” because the path cannot be planned in unexplored areas. FIG. 4 illustrates the OGM and the UDM created from the coarse map comparatively. It is seen that the primary aim of the UDM is to map distance in unoccupied space.

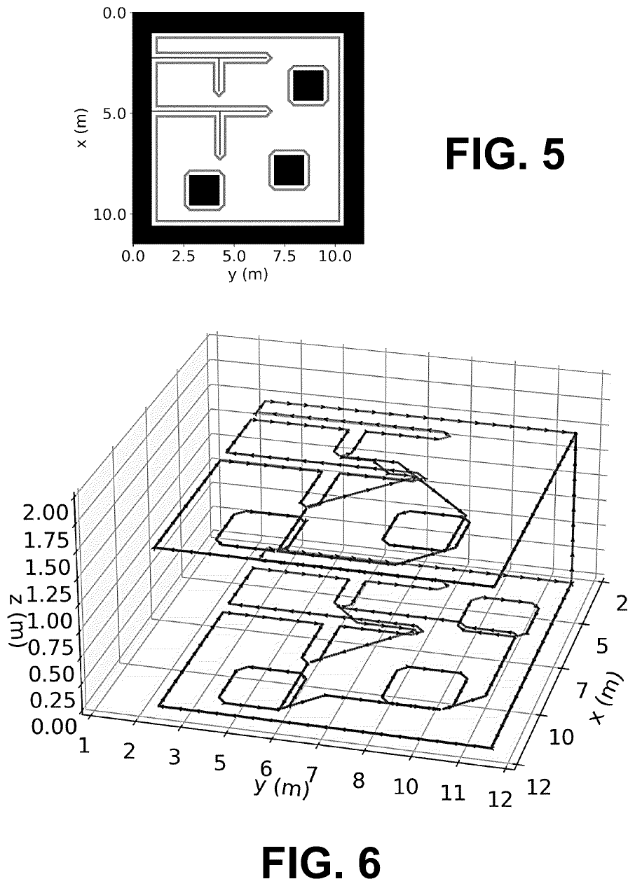

The proposed approach then identifies the grids of the UDM or the pixels of its image that have the targeted distance to the nearest structure. Let pⁱ* it be the pixel of the structure nearest to the pixel pⁱ and d* be the desired distance. The condition of the pixel to be a waypoint of the path is:

$${d}^{*} - \frac{1}{2} {‖ Δ p ‖}_{2} \leq {‖ {p}^{i} - {p}^{i *} ‖}_{2} < {d}^{*} + \frac{1}{2} {‖ Δ p ‖}_{2} , \qquad ( 4 )$$

where ∥⋅∥₂ indicates L² norm throughout the paper, and ∥Δp∥₂ is the distance between the two neighboring pixels, or the pixel resolution. A pixel is chosen within the pixel resolution to select the pixels indispensable to pass through. FIG. 5 shows the pixels selected to compose an offline path. As seen in FIG. 5, the pixels visualize well where the robot should visit through.

Since they are not connected, the pixels should form a path by connecting themselves but with minimum overlaps. While problems for finding a path to visit all the waypoints with minimum overlaps are known as TSP, the number of points is so large that this problem cannot be solved by plain TSP solvers in reasonable time. The problem of concern has the following unique constraint:
Constraint for offline path planning: Pixels representing the boundary of each structure are located near each other and sequentially expand along the contour. Thus, pixels along the boundary can be connected as segments of the planned path.

The proposed approach first connects the points near each other as segments. In this way, the dimension of path planning is significantly reduced since the problem is now defined as finding the order of start and end pixels of the segments to visit. Let the end pixel of the i-th segment and the start pixel of the j-th segment be pₑⁱ and pₛ^{j} respectively. In accordance with the TSP, the problem is formulated as:

$${min}_{{δ}_{ij}} {\sum }_{i} {\sum }_{j} {d}_{ij} {δ}_{ij} \qquad ( 5 )$$

where i, j ∈{1, . . . , n} and j ≠i. dᵢⱼ(>0) is the distance from the end pixel of the i-th segment pₑⁱ to the start pixel of j-th segment pₛⁱ. δᵢⱼ∈{0,1} which takes 1 if pₑⁱ and pₛ^{j} are connected as a part of the path. The Dantzig-Fulkerson-Johnson formulation adds the following constraints to complete the problem ensuring each and every point is visited once with no subtours:

$${{\sum }_{i = 1 , i \neq j}}^{n} {δ}_{ij} = 1 , ∀ j ∈ \{ 1 , … , n \} , \qquad ( 6 a )$$

$${{\sum }_{j = 1 , j \neq i}}^{n} {δ}_{i j} = 1 , ∀ i ∈ \{ 1 , … , n \} , \qquad ( 6 b )$$

$${\sum }_{j ∈ Q} {\sum }_{j \neq i , i ∈ Q} {δ}_{i j} \leq \vert Q \vert - 1 , ∀ Q ⊈ \{ 1 , … , n \} , \vert Q \vert \geq 2 , \qquad ( 6 c )$$

where Q is a subset. Solving the problem is to decide the values of δᵢⱼ. The proposed approach calculates dᵢⱼ based on Euclidean distance for fast computation. Since the number of segments is not large, this TSP problem can be solved using either exact algorithms or heuristic algorithms. After δᵢⱼ has been decided, the path from pₑⁱ to pₛ^{j} which δᵢⱼ=1 is planned to avoid obstacles by common motion planning algorithms, such as A star and D star.

FIG. 6 shows the resulting 3D path of two layers created after the 3D expansion. Since a 2D path is developed for each horizontal plane, the 3D expansion is completed by connecting a path point of one horizontal plane to a path point of the next horizontal plane. The objection located at x=5, y=10 does not reach the upper layer.

Online Map Refinement. Because the offline path is concerned only with the distance to the nearest structure, the robot path can be replanned and controlled online such that the map is finalized with the targeted resolution and local accuracy. To evaluate the resolution at a macroscopic scale, the proposed approach defines it in terms of pixel density. Suppose that the structure's surface of concern for the robot at time step k is Ωₖ. If the number of pixels the preceding coarse global mapping located to exhibit the surface is n_{Ω,k}⁽⁰⁾, the pixel density of the surface, D_{Ω,k}⁽⁰⁾, is given by:

$${D}_{Ω , k}^{( 0 )} = \frac{{n}_{Ω , k}^{( 0 )}}{{Ω}_{k}} . \qquad ( 7 )$$

The local accuracy, on the other hand, can be evaluated in terms of the characteristics of indoor structures. Since the surface of the indoor structure is geometric, poor local accuracy is often identified by the fluctuation of pixel locations. Let the mean deviation of the i-th pixel and the neighboring pixels from the fit plane be Γᵢ. The mean deviation of the surface of concern is given by:

$${Γ}_{Ω . k}^{〈 0 )} = \frac{1}{{n}_{Ω , k}^{( 0 )}} {\sum }_{{p}^{i} ∈ {S}_{Ω , k}^{( 0 )}} {Γ}_{i} . \qquad ( 8 )$$

The objective of the Step 2 online map refinement is to find the incremental motion Δxₖ^{r} that follows the path planned in the Step 1 offline planning and improves the resolution and the local accuracy:

$$J ( Δ {x}_{k}^{r} ) = {‖ {x}_{k + 1}^{r *} - {\hat{x}}_{k}^{r} - Δ {x}_{k}^{r} ‖}_{2} \to {min}_{Δ {x}_{k}^{r}} \qquad ( 9 )$$

where xₖ₊₁^{r}* is the desired next robot pose along the path and R& is the currently estimated robot pose. The control objective is subject to constraints so that the map meets the minimum criteria at time step k+1:

$${D}_{Ω , k + 1}^{( 2 )} ( Δ {x}_{k}^{r} ) \geq {D}^{*} , \qquad ( 10 a )$$

$${Γ}_{Ω , k + 1}^{( 2 )} ( Δ {x}_{k}^{r} ) \leq {Γ}^{*} . \qquad ( 10 b )$$

It is to be noted that d* is chosen so that the resolution criterion (10a) with D* is satisfied. Since the distance also controls the local accuracy, following the path planned in Step 1 satisfies the local accuracy criterion (10b) additionally if Γ* is chosen correspondingly. Nevertheless, the resolution and the local accuracy that the robot achieves in the actual mission would differ from the anticipated values. This necessitates the path replanning to ensure the targeted resolution and local accuracy is maintained.

Various sophisticated solutions are available for constrained nonlinear optimization, but the problem of concern with a linear objective function and light convex constraints can be solved relatively straightforward. The proposed approach can adopt a conventionally accepted solution and solve the problem by reformulating the objective function with penalties as:

$$J ( Δ {x}_{k}^{r} ) = {‖ {x}_{k + 1}^{r *} - {\hat{x}}_{k}^{r} - Δ {x}_{k}^{r} ‖}_{2} + {λ}_{D} min {\{ {D}_{Ω , k + 1}^{( 2 )} ( Δ {x}_{k}^{r} ) - {D}^{*} , 0 \}}^{2} + {λ}_{Γ} min {\{ {Γ}^{*} - {Γ}_{Ω , k + 1}^{( 2 )} ( Δ {x}_{k}^{r} ) , 0 \}}^{2} . \qquad ( 11 )$$

where λ_{D} and λ_{Γ}are the scaling factors.

The registration of the RGB-D camera point cloud is also straightforward. The newly observed point cloud should be matched to the preceding LiDAR point cloud through

Iterative Closest Point (ICP) method [20 ] to find the rigid transformation, δPₖ₊₁∈SE(3), between the coarse map points, I₀, and the new RGB-D points, Iₖ₊₁. The registration is performed as follows to find the pose of the new point cloud:

$$δ {P}_{k + 1} = {arg min}_{δ {P}_{k + 1}} {\sum }_{j ∈ J} {‖ δ {P}_{k + 1} {P}_{k + 1}^{r} {I}_{k + 1 , j} - {I}_{0 , j} ‖}_{2} \qquad ( 12 )$$

The pose composed by the Step 1 planned path and Step 2 replanning is converted to an SE(3) matrix, Pₖ₊₁^{r}, and used as the initial conditions for registration. The incoming RGBD point cloud is successfully registered to the preceding coarse map by applying the SE(3) transformations:

$${I}_{k + 1}^{*} = δ {P}_{k + 1} {P}_{k + 1}^{r} {I}_{k + 1} \qquad ( 13 )$$

The resulting point cloud, Iₖ₊₁*, can then be appended to the previously registered point clouds to form the refined map. By matching the incoming RGB-D point clouds to the prior LiDAR point cloud, the computation can be reduced while maintaining global accuracy since the global structure is already present.

### Mapping and Exploration

The exploration of a known and unknown environment has numerous similarities, since the goal is the same, but the methods change to accommodate the differing amounts of prior knowledge. To create a complete map of the environment, the exploration can be performed using a variant of complete-coverage path planning. Thus, the goal of exploration is to observe all of the desired surfaces in the environment with adequate certainty. Regardless of the method for exploration, the objective remains the same for exploring known and unknown environments.

When exploring an unknown environment, a map can be maintained to track the explored and unexplored regions of the environment. Typically, frontiers are then extracted from the map, and the robot will navigate through the environment until no more frontiers exist. This indicates the environment has been fully explored. When just considering the frontiers, the execution can be suboptimal, so the next-best view is used to improve the optimality of the path. By including information gain, the robot can observe the entire environment with minimal motion, which is desired to maintain high accuracy.

If the environment is known, then standard coverage path planning is easier, since the robot is just revisiting the environment. The planned path can be optimal, since the entirety of the scene is known. This also allows for path constraints to be followed more consistently than in frontier exploration. Common constraints for coverage path planning with respect to visual inspection include distance and orientation to the wall. Once all the viewing points which meet the specified criteria are selected, the points can be connected by:

$${L}_{path} = min {\sum }_{i} {\sum }_{j} {d}_{ij} {δ}_{ij}$$

where Lₚₐₜₕ is the total path length to be minimized, dᵢⱼ is the distance between points pi and p^{j}, and δᵢⱼ∈{0,1} is 1 when the path connects pⁱ and p^{j} and 0 otherwise. The optimization problem can be formulated and solved using numerous techniques, including the genetic algorithm. However, the dimensions of the basic formulation are too high to be reasonably solved without employing heuristics.

Need for a Multistage Approach. While the environment can be explored and a map can be created, the quality of the map is insufficient in two cases. The first case arises from the failure to cover all of surfaces with the depth-sensor measurements, ^{r}Iₖ, ∀k. In the second case, there may exist a depth-sensor measurement, ^{r}Iₖ, ∃k, which does not satisfy the targeted resolution. Both cases can occur when the 3D environment is considerably complex due to the changing geometry, even if a sophisticated Active SLAM technique is deployed. Since the low resolution is a result of measurement with distance, the local depth measurement may also be inaccurate. The map quality is insufficient in both the cases because the map becomes coarse. Even if a state-of-the-art exploration technique addresses these issues, standard SLAM techniques cannot be used to successfully create a fine map. This is due to the small number of geometric and visual features, which are used for pose estimation in many SLAM algorithms, being in the field of view of the sensor. Therefore, the pose estimation will likely be inaccurate even with the most robust SLAM techniques, and certainly unreliable. If the map is to be used to precisely represent the environment, the map must be accurate and have high spatial resolution to ensure all of the small details are recognizable.

The map created for global accuracy is generally poor in resolution and local accuracy, since both cannot be achieved simultaneously. This is due to the focus being on collecting scans with more information, such as geometric and visual features, which typically positions the sensor farther from to the surface. However, when creating a high-precision map, the sensor must observe the surfaces at a close distance to maintain high resolution and local accuracy. This indicates that a multimodal approach should be pursued when constructing a high-precision map to leverage the strengths of different sensors. All high-precision mapping approaches can be built on a coarse map with an emphasis on global accuracy. After a coarse map has been obtained, high-precision mapping be reliably achieved for large scales.

### Autonomous Robotic Data Collection

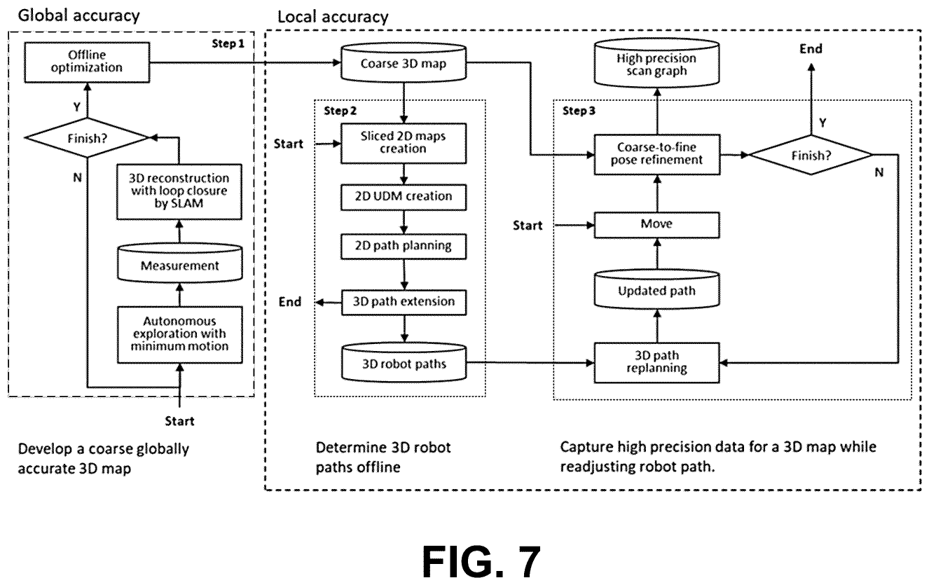

FIG. 7 shows a schematic diagram of an example of the proposed multistage framework for creating a high-precision map. The proposed framework starts by creating a coarse global map developed by conventional mapping with minimum motion as a constraint and focuses on collecting data to create a map to achieve the targeted resolution and local accuracy with an autonomous robot. Minimum motion, such as a single loop around the environment, can be used during coarse mapping to maintain the global accuracy by reducing the distance between pose estimations during SLAM or SfM. The depth sensors used for the proposed framework were a LiDAR, due to its high depth accuracy, and an RGB-D camera, due to its high aerial resolution. Consistent depth accuracy is needed in coarse global mapping because the robot may be away from the surrounding structures. This achieves global accuracy, though the robot is maintained close to its surrounding structures in the proposed framework to achieve the targeted resolution and local accuracy.

The proposed framework shown in FIG. 7 comprises three steps. The preceding step, Step 0, autonomously constructs a globally accurate coarse map of the environment to be used in the succeeding steps. To create a globally accurate coarse map, a 3D LiDAR can be used for its consistent depth uncertainty and large range. The coarse map can be created by using a conventional mapping technique, such as SLAM, and having the robot navigate through the unexplored environment with minimum motion. Since the proposed technique will later have the robot revisit the entire environment for high-precision observations, the coarse map does not have to be locally complete but should be globally complete.

The next step, Step 1, plans the 3D path of the robot offline, which maintains the desired distance to the nearest structure of the environment and approximately guarantees the minimum desired resolution and accuracy. Objects in an indoor environment can be generically classified as horizontal or vertical surfaces. Major horizontal surfaces include the floor and ceiling. Vertical surfaces mostly comprise the walls and other objects extending upwards from the floor. Therefore, planning can be done separately for the horizontal and vertical surfaces. Since the indoor environment is most often designed with horizontally stretched space, the coarse global map can first be sliced into multiple horizontal 2D planes, each with a different height, and an occupancy grid map (OGM) can be created for each 2D plane. Planes representing the floor and ceiling can then be used for planning revisiting major horizontal surfaces. This planning comprises basic-area-coverage path planning, so that the robot can revisit the entirety of the floor and ceiling for complete coverage. The remaining planes can be used for planning the path for the robot to revisit the vertical surfaces. The proposed framework creates an unoccupancy distance map (UDM) for each OGM and identifies pixels of the UDM image that have the desired distance to the nearest structure. The pixels of each layer are connected using a reduced-order travelling salesman problem (TSP) technique and results in the 2D path of the robot of the layer. In the final process of Step 1, the 2D paths can be connected so that the robot covers the 3D space in a single trip.

Step 2 replans a path and constructs a scan graph with RGB-D camera measurements online. While the offline path is concerned only with the distance to the nearest structure, the path replanned online navigates the robot such that the final data satisfies the targeted resolution and local accuracy. The robot moves not only to collect the expected data but also explores areas that were not identified in the coarse global mapping. This online path optimization corrects the predictions made in Step 1 approximating the resolution and local accuracy. Step 2 not only ensures the targeted resolution and local accuracy, but also the coverage completeness. Once the robot has moved, the RGB-D camera measurements can be aligned to finalize the pose estimations from coarse to fine. The process continues until the robot completes all of the data collection.

Globally Accurate Coarse Mapping. To create a high-precision map, a globally accurate coarse map of the environment is first created. If the map of the environment is known, from previous exploration or a BIM, and the results are globally accurate, then the preceding step (Step 0) can be skipped as previously discussed. In the cases where the environment is unknown, Step 0 is used to create a map of the environment with a focus on global accuracy.

To construct a map with high global accuracy, a rotating 3D LiDAR can be used for its wide field of view, large range, and consistent error with respect to distance. Basic frontier exploration can be used to navigate through the environment to create a globally complete map. The exploration does not have to lead to a locally complete map, so the focus can be on reliable exploration with minimum motion. Since the objective of Step 0 is to maximize the global accuracy, there is a desire to minimize motion of the robot to reduce errors associated with pose estimation by considering the information gain associated with the next planned position. During exploration, a generic 3D SLAM algorithm, with support for a variety of sensors, can be used to construct the globally accurate 3D map. Since many SLAM techniques rely on feature matching, the angular velocity of the sensor should be minimized to reduce the changes in position of tracked features. The resultant map will be globally complete and accurate-a suitable map for planning and navigation.

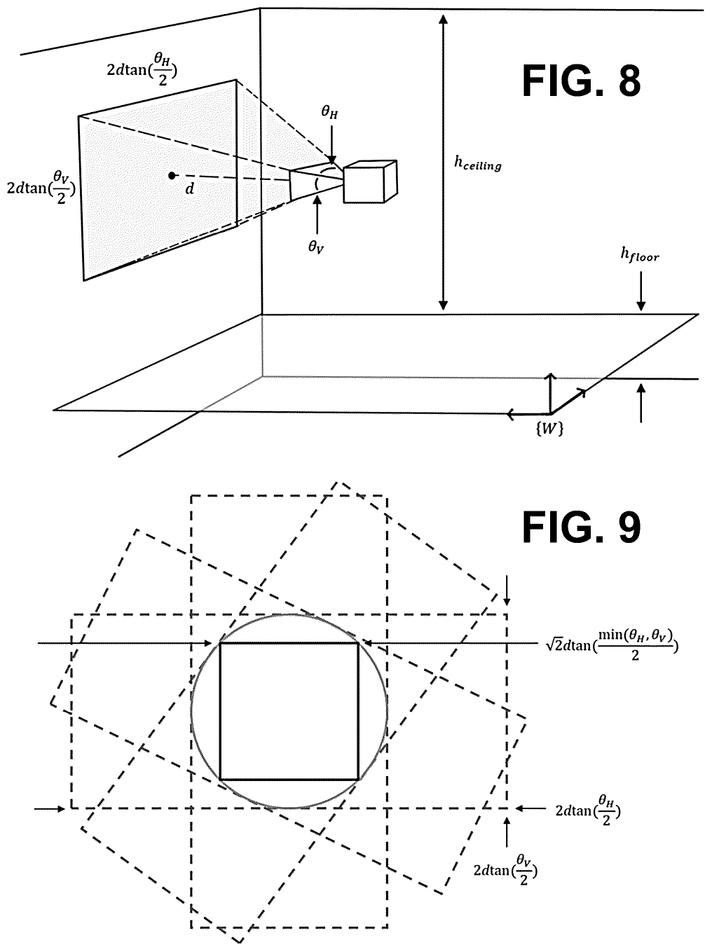

Offline 3D Path Planning for Complete Surface Coverage. Step 1 of the proposed framework aims for the targeted resolution and local accuracy to be achieved by planning the path of the robot so that its corresponding targeted distance to the nearest structure of the environment is maintained. For offline path planning, the resolution and local accuracy at each point can only be predicted. The generic setup for the offline prediction for path planning can be seen in FIG. 8, which illustrates an example of a sensor field of view projected onto a wall in the environment. The spatial resolution and accuracy of a visual sensor are inversely proportional to measuring distance. Small distances imply higher spatial resolution and accuracy. Spatial resolution of a theoretical scan near a planar surface can be given by:

$$\hat{D} ( d ) = \frac{mn}{4 {d}^{2} tan ( \frac{H}{2} ) tan ( \frac{V}{2} )} \qquad ( 14 )$$

where m by n is the sensor resolution, H by V is the field of view, and d is the distance to the center of the measurement. The accuracy is not easily defined, so conversely, the error of the depth measurement can be used instead. The depth error is typically given as a proportion of the sensor reading, so the predicted error is:

$$\hat{Γ} ( d ) = d σ \qquad ( 15 )$$

where σ is the reported accuracy. The targeted distance, d*, is the estimated distance to achieve the targeted resolution and local accuracy. It can be estimated by:

$${d}^{*} = {argmin}_{d} \{ {{λ}_{\hat{D}} ( \hat{D} ( d ) - {D}^{*} )}^{2} + {{λ}_{\hat{Γ}} ( {Γ}^{*} - \hat{Γ} ( d ) )}^{2} \} \qquad ( 16 )$$

where D* is the targeted spatial resolution, Γ* is the targeted error, and λ_{\hat{D}} and λ_{\hat{Γ}} are the scaling factors.

To ensure that autonomous path planning does not fail in a complex 3D environment and being aware that the indoor space is stretched horizontally, the robot can be planned to revisit the entire 3D space by moving horizontally at different heights. The observation height for the floor, ₕh₀, and ceiling, ₕh₁, are defined by:

$${}_{h} {h}_{0} = {h}_{floor} + {d}^{*} , \qquad ( 17 )$$

$${}_{h} {h}_{1} = {h}_{ceiling} - {d}^{*} \qquad ( 18 )$$

where h_{floor} is the height of the floor and h_{ceiling} is the height of the ceiling. Since the aim of the proposed technique includes coverage completeness, a unit viewing area can be defined for the sensor. This ensures that regardless of the orientation about the viewing axis, everything in the unit viewing area is observed. The unit viewing dimension can be calculated by rotating the field of view about the center point and inscribing a circle. FIG. 9 illustrates the unit viewing area for a sensor at a given distance, given by rotating the field of view and inscribing a square into the union of all of the fields of view. A square was then inscribed in the circle to determine the unit viewing area at the targeted distance, as given by:

$${l}_{view} = \sqrt{2} {d}^{*} tan ( \frac{min \{ H , V \}}{2} ) \qquad ( 19 )$$

where l_{view} is the unit length of the unit viewing square.

The number of horizontal slices, nₕ, corresponding the major vertical surfaces depends on the height of the environment and field of view of the sensor. It can be given by:

$${n}_{h} = ⌈ \frac{{h}_{ceiling} - {h}_{floor}}{{l}_{view}} ⌉ \qquad ( 20 )$$

where [⋅] is the ceiling operator. Since the number of layers must be an integer, the ceiling operator is used instead of the rounding operator or the floor operator to ensure that the entire vertical surface is observed. The different layer heights, ᵥhᵢ, are:

$${}_{v} {h}_{i} = \frac{{h}_{ceiling} - {h}_{floor}}{{n}_{h}} ( i - \frac{1}{2} ) + {h}_{floor} , ∀ i ∈ \{ 1 , … , {n}_{h} \} \qquad ( 21 )$$

where the heights are evenly distributed from the floor to the ceiling.

Let the i-th grid pⁱ=[xⁱ, yⁱ]^{T} of the 2D OGM created by slicing the coarse global 3D map of the conventional mapping at the defined heights be given by Eqn. (2), where m_{OGM}(⋅) is the occupancy grid mapping operator. The OGM conventionally outputs the values of 0, ½ and 1 for occupied, unexplored and unoccupied grids, respectively. The proposed approach re-expresses the OGM as the Euclidean UDM towards planning a 3D path offline and returns an unoccupancy distance as given by Eqn. (3), where m_{UDM}(⋅) is a revised version of the OGM operator that outputs the distance of the grid from the nearest occupied grid. The distance in the UDM is 0 when the grid is “unexplored” in addition to “occupied.” The state of “unexplored” is treated equally to the “occupied” because the path cannot be planned in unexplored areas. FIG. 8 illustrates the OGM and the UDM created from the coarse map comparatively. It is seen that the primary aim of the UDM is to map distance in unoccupied space.

For map slices representing the major horizontal surface, which corresponds to the floor or ceiling, the robot revisits the entire available area. This is also known as coverage path planning. Typically, the environment is discretized in a grid map, and each grid cell is a point for the robot to visit. Since the aim of the proposed framework is to map the entire surface at a specified distance, d*, the grid cells can be resized to correspond to the field of view of the sensor. Simply, the grid cells can be resized to match the unit viewing length. By using the minimum dimension of the sensor field of view, it ensures that regardless of the orientation the entire area of the grid cell will be observed.

After the OGM has been resized, with the grid cells being roughly the same size as the sensor field of view, a simple coverage path planning algorithm can be used. A variety of techniques can be used to visit each cell, each with different optimality criteria. This approach can use the boustrophedon technique to plan a path through each cell due to its many straight paths, which will minimize unnecessary change in motion for most of the environment. The path planning technique just connects all of the points together into a single path; the sensor orientation is not considered until after the path is complete. Since the motion and the surfaces of interest are in parallel planes, the sensor orientation is constant for the entire path with the sensor facing the surface of interest.

The remaining map slices will correspond with the major vertical surfaces, primarily the walls, so the robot follows the perimeter of the map. The proposed framework then identifies the grids of the UDM or the pixels of its image that have the targeted distance to the nearest structure. Let pⁱ* be the pixel of the structure nearest to the pixel pⁱ. The condition of the pixel to be a waypoint of the path is given by Eqn. (4). A pixel is chosen within the pixel resolution to select the pixels that are necessary to pass through. FIG. 9 shows the pixels selected to compose an offline path.

Since they are not connected, the pixels should form a path by connecting themselves but with minimum overlaps. While problems for finding a path to visit all the waypoints with minimum overlaps are known as TSP, the number of points is so large that this problem cannot be solved by plain TSP solvers in a reasonable time. The problem of concern has the following unique constraint: Pixels representing the boundary of each structure can be located near each other and sequentially expand along the contour. Thus, pixels along the boundary can be connected as segments of the planned path.

The proposed framework first connects the points near each other as segments. In this way, the dimension of path planning can be significantly reduced, since the problem can be defined as finding the order of start and end pixels of the segments to visit. Let the end pixel of the i-th segment and the start pixel of the j-th segment be pₑⁱ and pₛ^{j} respectively. In accordance with the TSP, the problem is formulated as given by Eqn. (5). The Dantzig-Fulkerson-Johnson formulation adds the constraints of Eqns. (6a)-(6c). Solving the problem is to decide the values of δᵢⱼ. The proposed approach calculates dᵢⱼ based on the Euclidean distance for fast computation. Since the number of segments is not large, this TSP problem can be solved using either exact algorithms or heuristic algorithms. After δᵢⱼ has been decided, the path from pₑⁱ to pₑⁱ which δᵢⱼ=1 is planned to avoid obstacles by common motion planning algorithms, such as A star and D star. The desired sensor orientation can be added to each of the points along the path by obtaining the normal of n nearest occupied pixels. The normal of the pixels is computed by using random sample consensus (RANSAC) to fit a line through the points and finding an orthogonal direction vector by:

$$θ = arctan ( \frac{1}{m} )$$

$$v - [ \begin{matrix}cos θ \\ sin θ\end{matrix} ]$$

where m is the slope computed from RANSAC, θ is the normal angle, and v is the direction vector for the sensor.

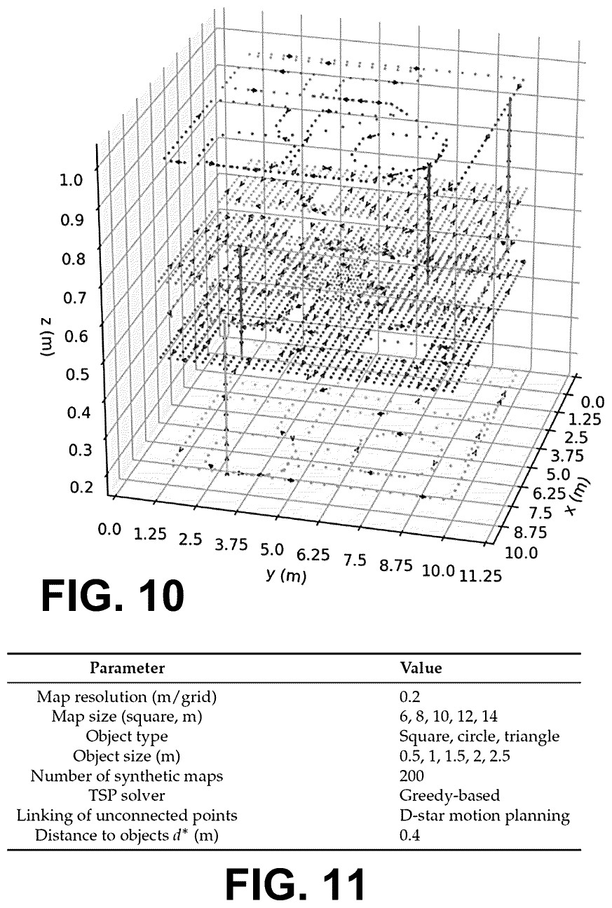

FIG. 10 shows the resulting 3D path created after the 3D expansion. Since a 2D path is developed for each horizontal plane, the 3D expansion is completed by connecting a path point of one horizontal plane to a path point of the next horizontal plane. FIG. 10 illustrates the resulting 3D offline path of the room with two horizontal layers and three vertical layers. The object located at x=4, y=9 does not reach the upper-most layer.

Online Path Optimization for Targeted Metrics. The path planned in Step 1 only approximately guarantees the resolution and local accuracy because the offline path is concerned only with the distance to the nearest structure. Therefore, as the path is followed by the robot using localization from the rotating 3D LiDAR, the path can be replanned and controlled online based on the measured resolution and local accuracy. The online path optimization guarantees the map can be finalized with the targeted resolution and local accuracy. To evaluate the resolution at a macroscopic scale, the proposed framework defines it in terms of pixel density. Suppose that the structure's surface of concern for the robot at time step k is Ωₖ. If the number of pixels from the data to exhibit the surface is n_{Ω,k}, the pixel density of the surface, D_{Ω,k}, is given by:

$${D}_{Ω , k} = \frac{{n}_{Ω , k}}{{Ω}_{k}} . \qquad ( 22 )$$

The local accuracy, on the other hand, can be evaluated in terms of the characteristics of indoor structures. Since the surface of the indoor structure is geometric, poor local accuracy is often identified by the fluctuation of pixel locations. Let the mean deviation of the i-th pixel and the neighboring pixels from the fit plane be Γᵢ. The mean deviation of the surface of concern is given by:

$${Γ}_{Ω , k} = \frac{1}{{n}_{Ω , k}} {\sum }_{{p}^{i} ∈ {S}_{Ω , k}} {Γ}_{i} . \qquad ( 23 )$$

The objective of the online path optimization in Step 2 is to find the incremental motion Δxₖ that follows the path planned in the Step 1 offline planning and improves the resolution and the local accuracy:

$$J ( Δ {x}_{k} ) = {‖ {x}_{k + 1}^{*} - {\hat{x}}_{k} - Δ {x}_{k} ‖}_{2} \to {min}_{Δ {x}_{k}} \qquad ( 24 )$$

where xₖ₊₁* is the next desired robot pose along the path, and \hat{x}ₖ is the currently estimated robot pose. The control objective is subject to constraints so that the map meets the minimum criteria at time step k+1:

$${D}_{Ω , k + 1} ( {Δx}_{k} ) = {D}^{*} , \qquad ( 25 )$$

$${Γ}_{Ω , k + 1} ( {Δx}_{k} ) = {Γ}^{*} . \qquad ( 26 )$$

The resolution and the local accuracy that the robot achieves in the actual mission would differ from the predicted values in Step 1. This path replanning ensures the targeted resolution and local accuracy are maintained.

Various sophisticated solutions are available for constrained nonlinear optimization, but the problem of concern with a linear objective function and light convex constraints can be solved relatively straightforwardly. The proposed framework can adopt a conventionally accepted solution and solve the problem by reformulating the objective function with penalties as:

$$J ( Δ {x}_{k} ) = {‖ {x}_{k + 1}^{*} - {\hat{x}}_{k} - Δ {x}_{k} ‖}_{2} + {{λ}_{D} ( {D}_{Ω , k + 1} ( {Δx}_{k} ) - {D}^{*} )}^{2} + {{λ}_{Γ} ( {Γ}_{Ω , k + 1} ( {Δx}_{k} ) - {Γ}^{*} )}^{2} \qquad ( 27 )$$

where λ_{D} and λ_{Γ}are the scaling factors.

Since the pose is initially estimated by the rotating 3D LiDAR, the measurements have high uncertainty, which is not suitable for high-precision mapping. The pose refinement can be performed through the alignment of the RGB-D camera point cloud to the coarse map. Since the coarse map is globally accurate and there is an initial estimate of the camera pose, the alignment of the RGB-D camera point cloud is also straightforward.

The newly observed point cloud should be matched to the preceding map point cloud through the ICP method to find the rigid transformation, λPₖ₊₁∈SE(3), between the coarse map points, I₀, and the new RGB-D points, Iₖ. The pose composed by the Step 1 planned path and Step 2 replanning can be measured by the rotating 3D LiDAR and converted to an SE(3) matrix, Pₖ^{r}, to be used as the initial conditions for registration. The registration is performed as follows to find the pose of the new point cloud:

$$δ {P}_{k} = {argmin}_{δ {P}_{k}} {\sum }_{j ∈ J} {‖ δ {P}_{k} {P}_{k}^{r} {I}_{k , j} - {I}_{0 , j} ‖}_{2} \qquad ( 28 )$$

The incoming RGB-D point cloud is successfully aligned to the preceding coarse map by applying the SE(3) transformations. The resultant pose from the alignment is represent by:

$${P}_{k}^{*} = δ {P}_{k} {P}_{k}^{r} \qquad ( 29 )$$

where Pₖ* is the refined pose estimate from the ICP refinement. By matching the incoming RGB-D point clouds to the prior LiDAR point cloud, the computation is reduced while maintaining global accuracy, since the global structure is already present.

### Numerical/Experimental Validation

The proposed approach of map refinement and framework of autonomous data collection was tested and validated through parametric studies and real-world application. The path planning of Step 1 was investigated with synthetic maps which were generated by positioning different kinds of objects on given grid maps. The quality of maps and collected data were studied parametrically after the Step 2 online map refinement. The autonomous mission of Steps 1 and 2 in a practical environment was demonstrated.

Planning Performance of Step 1. The table of FIG. 11 lists the parameters used for path planning of Step 1. The synthetic maps were generated by positioning three kinds of objects (square, circle, and triangle) on a given map of random size. The object may or may not appear on each map, and the position and rotation of each object are also random. The performance of the reduced-order TSP planning technique, for vertical observations, was assessed for completion and time during validation.

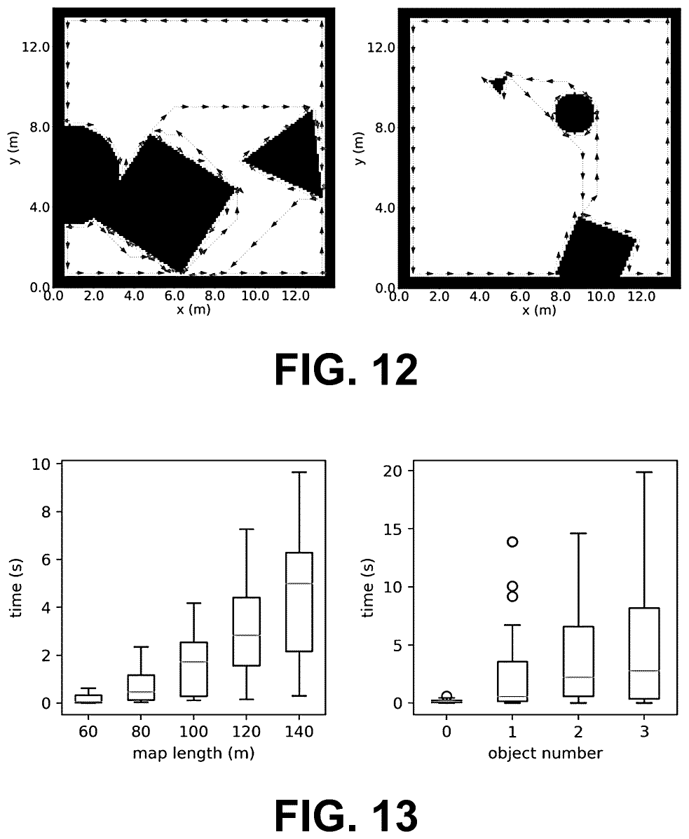

FIG. 12 shows two examples of the synthetic map and the planned paths. The planned paths are indicted by the dotted lines and the dynamically sequential movement along the path is shown by the arrows indicated along the path. In the test, paths were successfully planned for all of the generated environments. Since the motion planning algorithm links the endpoints of two disconnected segments, if many pairs of endpoints need to be connected, the planning would take considerable time.

FIG. 13 shows box plots of the computation time with respect to the map size and the number of objects positioned in the environment. The computation time is defined as the time of completion for the entirety of Step 1 including: preprocessing of the distance transform, solving TSP, and D star motion planning. The computation time of planning was recorded for all 200 maps. The mean computation time increased as the map size and the number of objects became larger. This was because the motion planning consumes more time when the map is bigger and the environment is more complex due to more positioned objects. Among the computation time, the motion planning takes the majority of the time at 89.66% of the entire time.

Mapping Evaluation of Step 2. To test the validity of Step 2, a known and controlled environment was constructed for repeatable testing and comparisons. Since the proposed approach assumes a globally accurate coarse map, the experiment used a rotating LiDAR to generate the coarse map given its precise measurement irrespective to the distance. For the map refinement, a depth camera was added as its measurement precision is ensured when the objects are near, which is ensured following the path of Step 1. For local metric evaluation, a path was not planned using Step 1, as the purposed of this experiment was to test the performance of Step 2 to achieve the desired metrics. The robot was instructed to move past the objects at an approximate distance with the online optimization to be followed to guarantee the desired metrics. For Step 2, a depth camera was added, as its measurement precision was ensured when the objects were near, which was ensured by following the path of Step 1.

The main focus of the parametric study was to quantitatively determine local accuracy and resolution of the proposed approach compared to the conventional techniques. Since the resolution is a function of the 3D reconstruction method, which can sometimes include interpolating functions, the resolution was compared to the desired resolution used in Step 2. The local accuracy was compared to conventional techniques to determine the effectiveness of the pose estimation. A standard SLAM package, RTAB-Map, was used as the conventional mapping technique using the default recommended parameters for each respective sensor. RTAB-Map was used as the conventional SLAM package due to its extensive support for different sensors allowing for continuous use in future experiments.

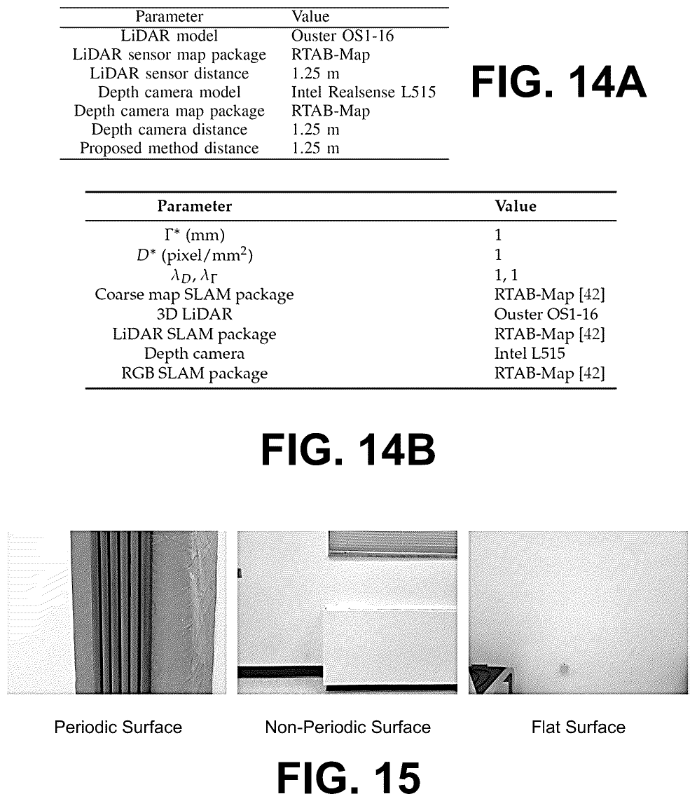

The table of FIG. 14A describes the sensor distance used to during the experiment. The table of FIG. 14B describes the desired metrics, sensor distance, and other parameters used to during the experiment. An approximate distance, similar to the value calculated in Step 1, was used to determine whether the online optimization was necessary. The same path was followed at a distance of 1.25 m for all sensors. The distance was chosen so both the LiDAR and the depth camera could maintain global accuracy as moving closer would be close to the minimum sensor range for the LiDAR and severely limit the field of view of the depth camera. This would disrupt the pose prediction and registration of conventional techniques. The local accuracy and resolution were tested on the same surfaces, periodic surface (left), non-periodic surface (middle), and flat surface (right) as seen in FIG. 15, located within a room for all sensors to ensure adequate evaluation. A ground truth model was created by measuring the environment and drafting a CAD model for comparison.

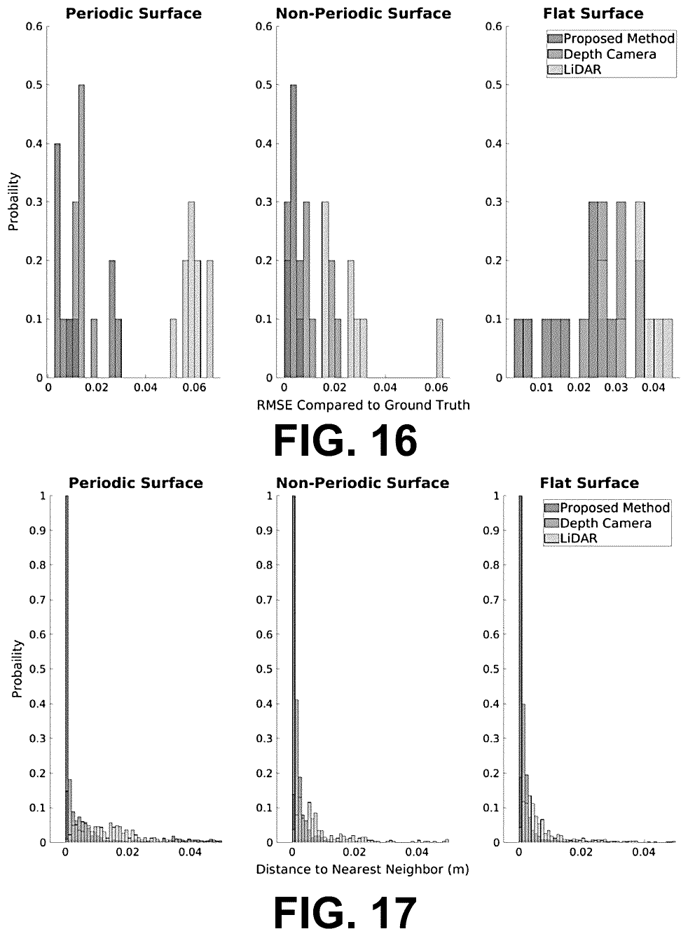

The results of the study fully validate Step 2 by showing consistently high local accuracy and resolution on all of the test structures. The local accuracy was computed by comparing the resultant point cloud to the ground truth 3D model of the structures of interest. The point cloud was sliced horizontally to generate more samples so the accuracy could be individually compared at multiple layers. As seen in FIG. 16, the local accuracy of the proposed approach is similar to the depth camera and significantly better than the LIDAR. These are optimal results as the local accuracy of the proposed approach is similar to the reported values on the sensor data sheet. Resolution was calculated by finding the distance between every point and its nearest neighbor, with the goal being to have as small a distance as possible. FIG. 17 shows the increased resolution of the point cloud while using the proposed approach, with all points being within 1 mm of its nearest neighbor. The conventional approaches were shown to achieve this resolution occasionally but the high variability is not suitable for consistent high resolution mapping.

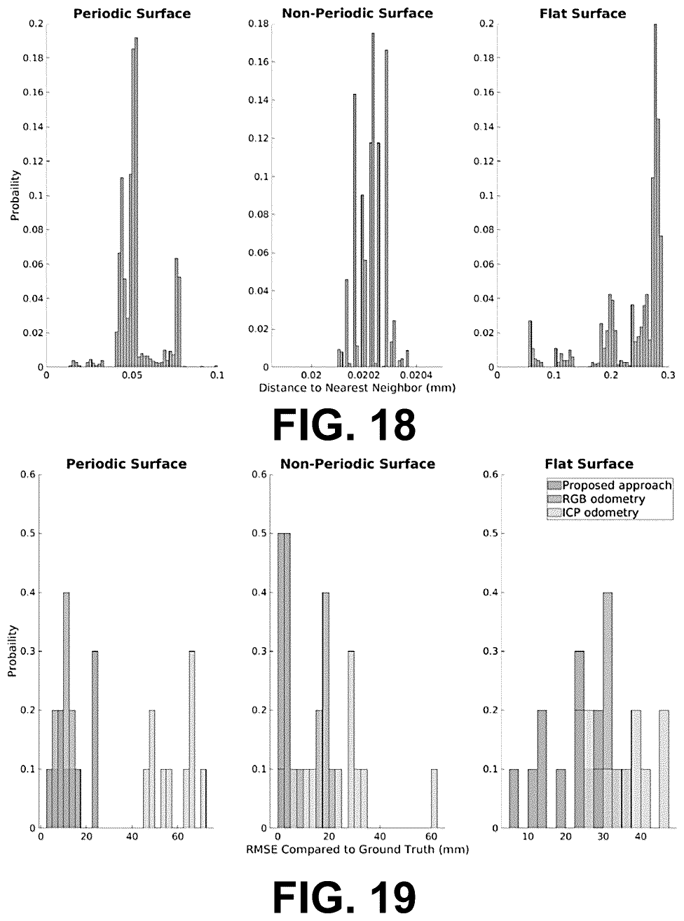

Resolution was calculated by finding the distance between every point and its nearest neighbor, with the goal being to have as small a distance as possible. FIG. 18 shows the higher resolution of the point cloud while using the proposed framework, with all points being within 1 mm of their nearest neighbors. The local accuracy was computed by comparing the resultant point cloud to the ground truth 3D model of the structures of interest. The point clouds of the collected data were assembled using basic registration of the point clouds from the computed poses. The point cloud was sliced horizontally to generate more samples so the accuracy could be individually compared among varying heights. As seen in FIG. 19, the local accuracy of the proposed framework is significantly better than that of the ICP odometry and at least as good as that of the RGB odometry. These are optimal results as the local accuracy of the proposed framework is similar to the reported values on the sensor data sheet.

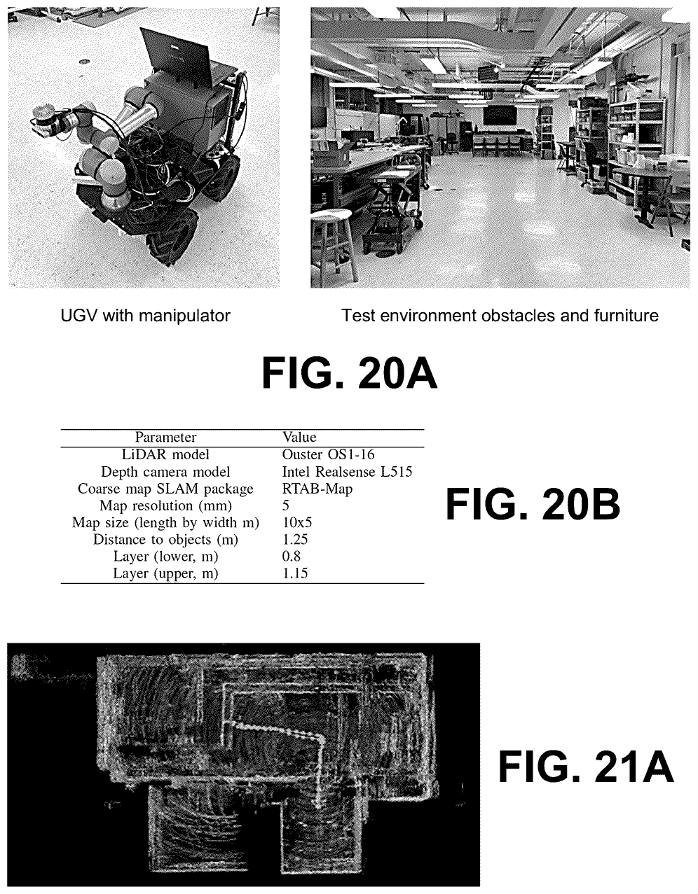

Autonomous Map Refinement of Practical Environment. FIG. 20A shows the robot and the indoor environment that were used for a first real-world experiment. The robot comprises a wheeled platform and a manipulator on top of it. Both the 3D LiDAR and the depth camera were attached to the end of the manipulator. The manipulator allows the positioning of the sensors in 3D space, which leads to the creation of a refined 3D map. The indoor environment is a typical robotics laboratory that has various furniture facing the wall and an open area. Since the furniture does not go all of the way to the ceiling, the sliced 2D maps will be different depending on the height.

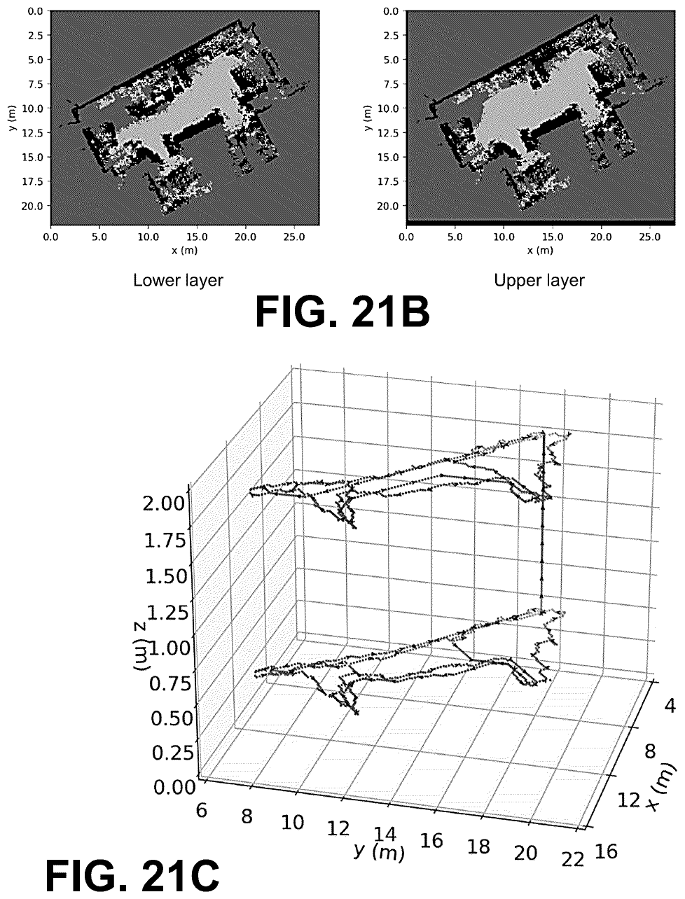

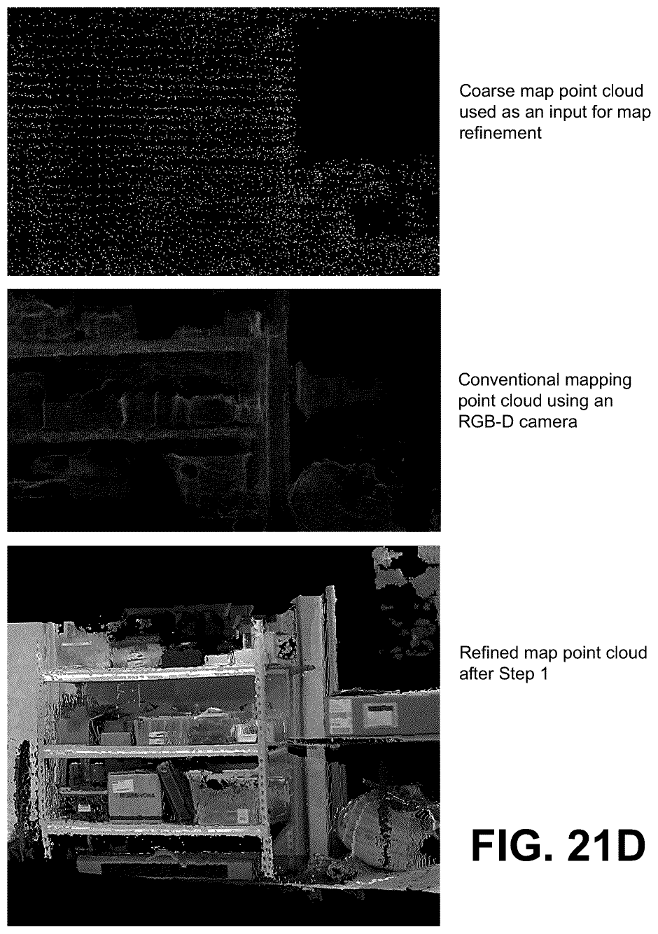

The table of FIG. 20B lists the parameters of the experiment. RTAB-Map was used as the coarse map SLAM package due to its extensive capability. FIG. 21A shows the point cloud of the coarse map used in the map refinement. The map shows global accuracy as the boundary of the room is well loop-closed. The LiDAR was set to cover a vertical range of 1.04 m when the distance was 1.25 m and was set at two different heights as listed in the table of FIG. 20B. Since the LiDAR has 16 horizontal lines, a minimum resolution of 65 mm can be achieved by keeping the distance of the robot to the structure to 1.25 m. The occupancy grid maps of different heights were generated and used as the inputs to the proposed approach.

FIG. 21B shows OGMs of the two layers (lower and upper). The OGMs are seen to differ from each other to some extent due to the presence of structures at different heights. This endorses the need for path planning at each height. FIG. 21C shows the final 3D offline path after running the proposed approach. The path is followed by the robot to traverse the environment and refine the coarse map. The Robot Operating System (ROS) navigation stack was used as the backbone for movement of the mobile platform. The robot arm stretches to reach the upper layer at the connecting position of the two layers. While the path planning for synthetic maps was always successful, following the path depends on more factors. For instance, the robot would sometimes become stuck in positions when the distance to objects is set too small.

FIG. 21D illustrates a comparison of the coarse map to a conventional mapping and the refined map featuring a section of the test environment containing shelves and boxes. FIG. 21D shows a section of the coarse map (top) along with the refined map (bottom) following Step 2 and conventional mapping (middle) as a comparison. As seen in the parametric study, the low local accuracy and resolution of the conventional techniques can leave surfaces unidentifiable. However, the proposed approach creates a map that is clearly recognizable due to the verifiable high local accuracy and resolution.

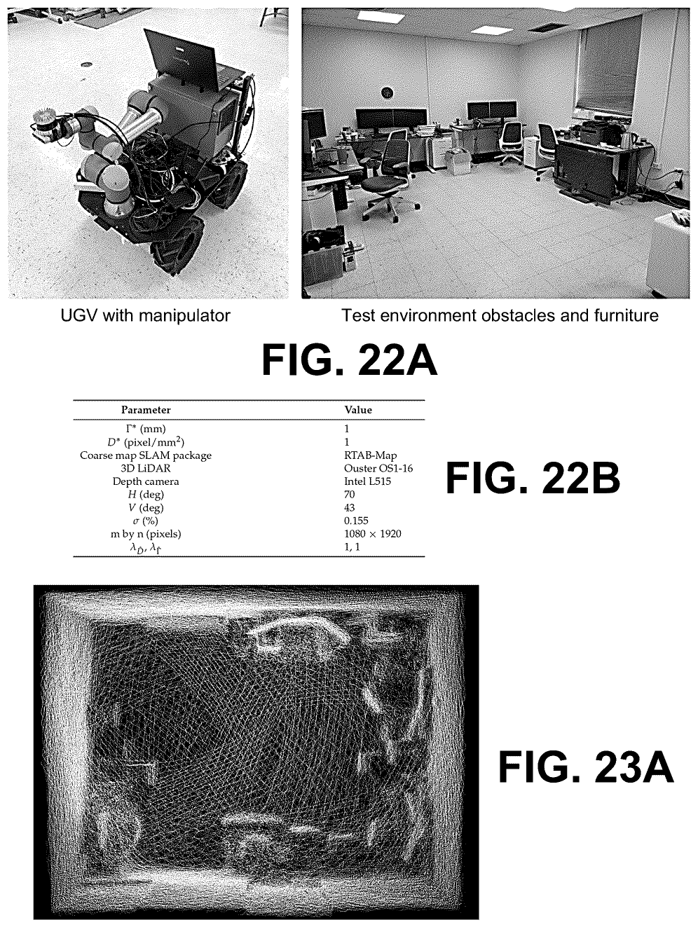

FIG. 22A shows the robot and another indoor environment that were used for a second real-world experiment. The indoor environment is a typical workplace office that has various furniture facing the wall and an open area. Since the furniture does not go all of the way to the ceiling, the sliced 2D maps differ depending on the height.

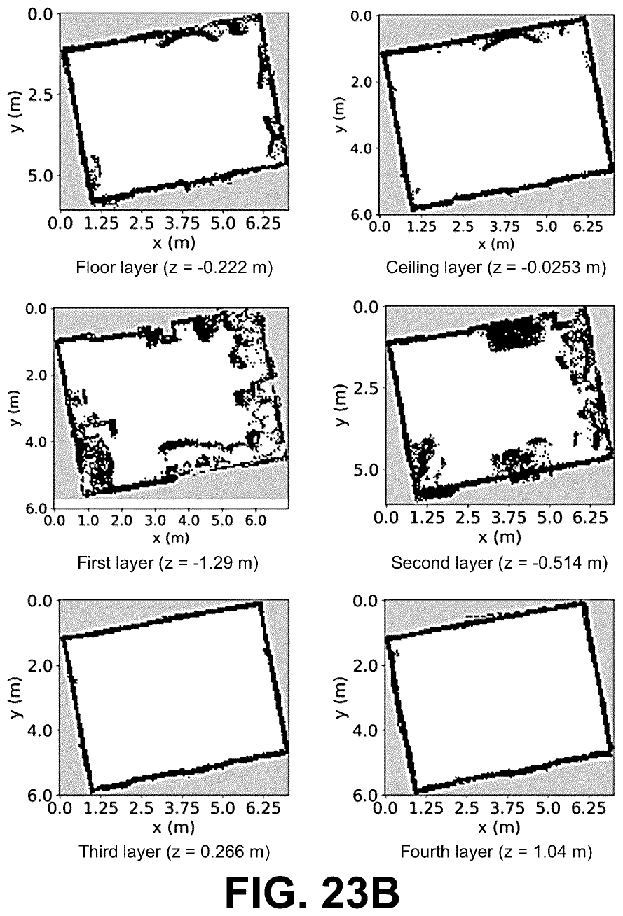

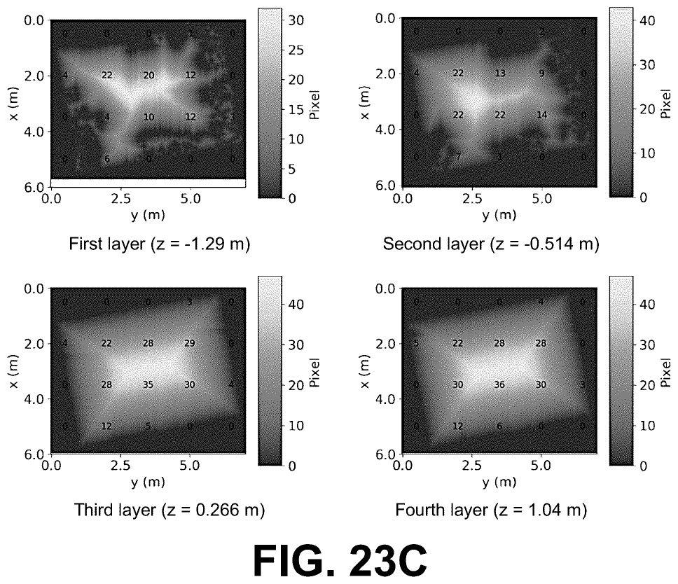

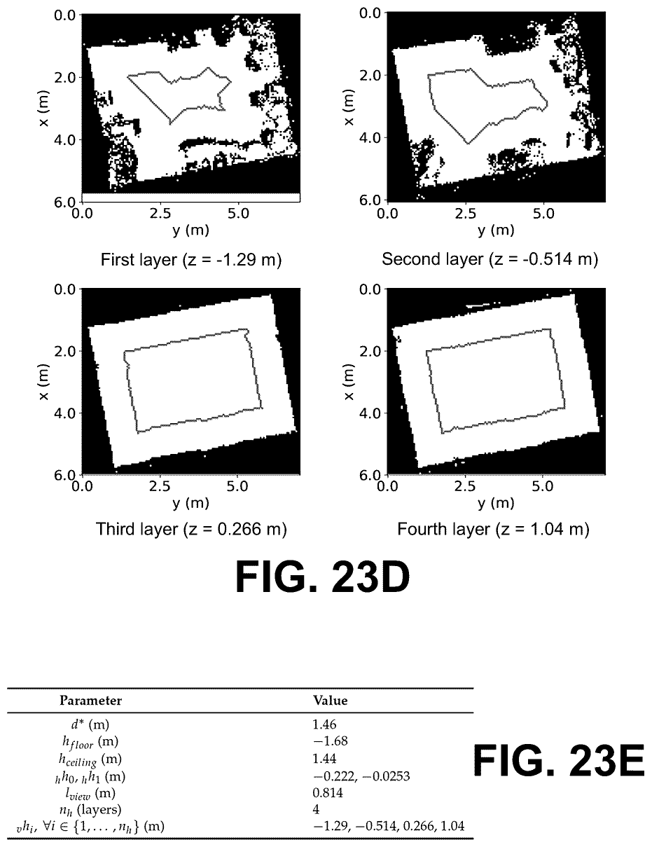

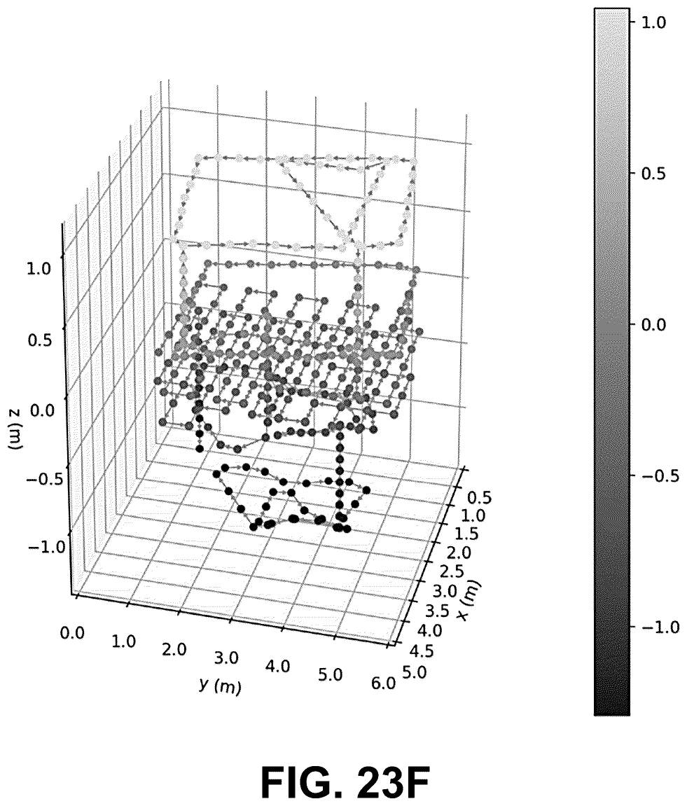

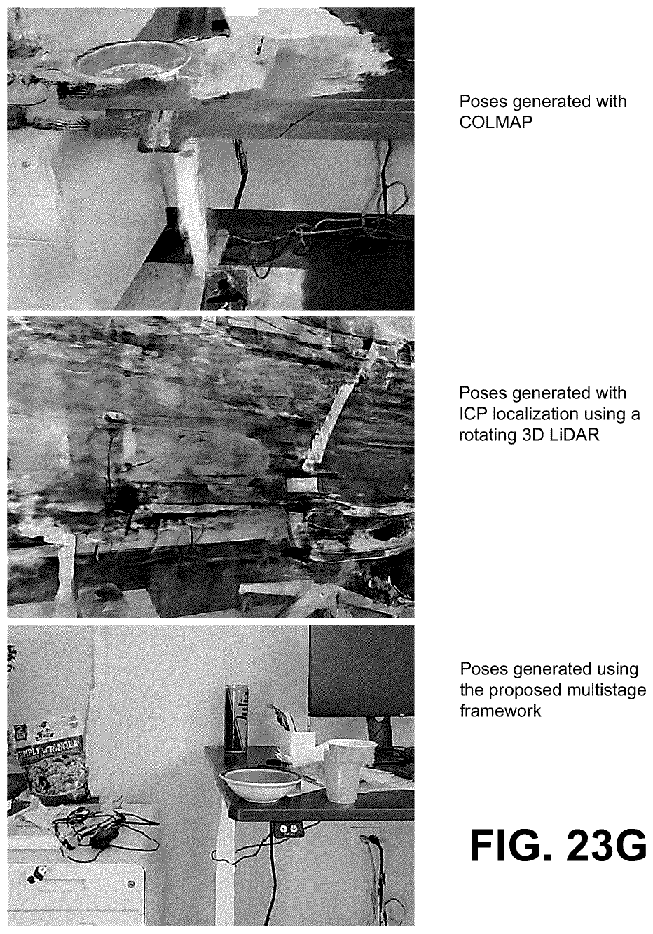

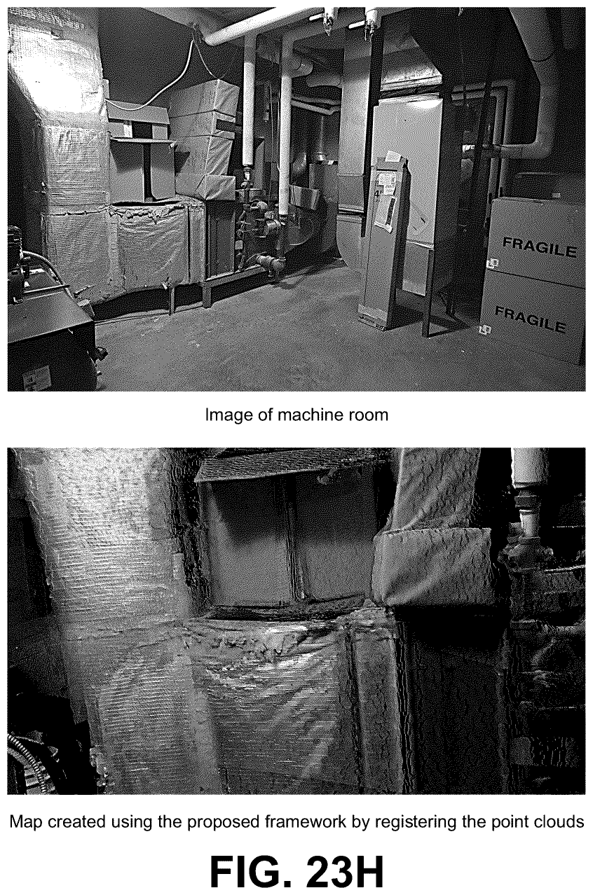

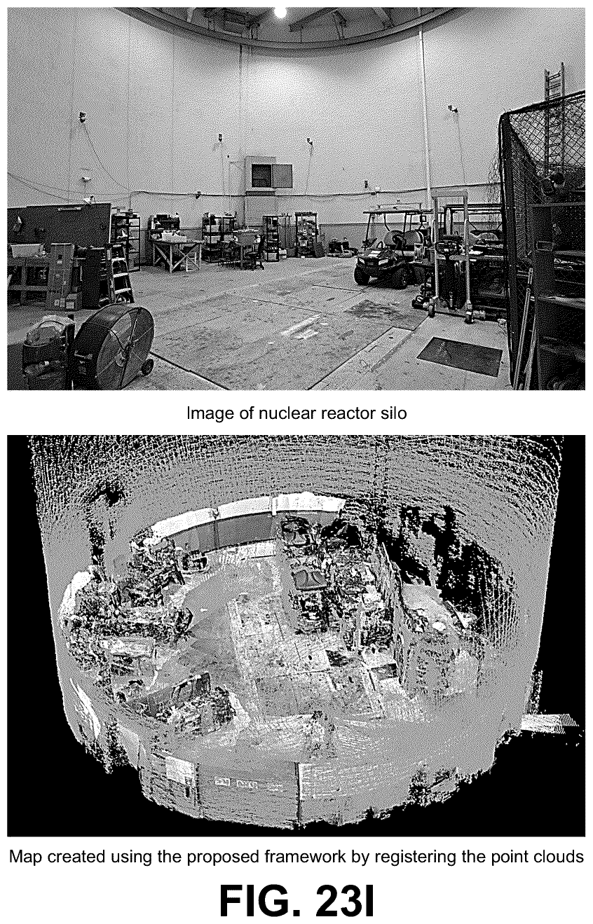

The table of FIG. 22B lists the input parameters of the experiment. The SLAM package for coarse mapping and sensors was not changed. FIG. 23A shows the point cloud of the coarse map used in the pose refinement. The map shows global accuracy as the boundary of the room is square, indicating it is well loop-closed. The occupancy grid maps of different heights were generated, as seen in FIG. 23B, and used as the inputs to the proposed framework. The OGMs are seen to differ from each other to some extent due to the presence of structures at different heights, confirming the need for path planning at each height. The UDMs in FIG. 23C, selected pixels for the traversal in FIG. 23D, the path planned for each layer in FIG. 23D, and the computed values are shown in the table of FIG. 23E for completeness.

FIG. 23F shows the final 3D offline path computed by Step 1. Some of the z values are negative, since the origin of the map is located 1.68 m above the ground, where the coarse mapping began. The heights of the floor and ceiling are indicated in the table of FIG. 23E, which control the range of the heights used for the planned path. The path was followed by the robot to traverse the environment and refine the coarse map. The ROS1 navigation stack with move_base used as the backbone for movement of the mobile platform. The robot arm extended to reach the different layers and moved to perform fine motion corrections. While the path planning for synthetic maps was always successful, following the path depended on more factors. The performance of the path following was restricted by the dynamic and kinematic constraints of the mobile robot. For instance, the robot sometimes became stuck in positions when the distances to objects were set to be too small due to the non-holonomic constraints provided by the mobile robot. If a robot has holonomic constraints, such as a mobile robot with mecanum wheels or a hexacopter, the ability to recover motion in tight spaces is improved.

FIG. 23G illustrates a comparison of the resulting NeRF renderings using different techniques to estimate the poses of the images. FIG. 23G shows a section of the map generated by NeRF after using the proposed framework. Different pose estimation techniques were used to compute the poses necessary for NeRF. The proposed framework was tested alongside commonly used techniques, such as COLMAP (top) and LiDAR localization (middle). The practical test was repeated in other environments with different layouts to determine the robustness of the proposed framework. The test environments include a machine room, as seen in FIG. 23H, and a nuclear reactor's silo, as seen in FIG. 23I. For these, the maps are represented by the point clouds registered together at the respective refined poses computed from Step 2. The machine room is a small and unstructured environment, proving the proposed approach can handle tight enclosed spaces. The nuclear reactor's silo is vertically high, showing the capabilities even when the structure is tall. There is no ceiling for the high-precision map due to the height of the structure, and the LiDAR point cloud remains to show the skeleton structure of the space. The performances in many different environments show the proposed framework can be used in many real-world settings and applications.

As predicted, the pose estimation of the conventional techniques is not suitable for collecting images with high spatial resolution. As shown similarly in the parametric study, the low local accuracy and resolution of the conventional techniques can leave surfaces blurry and unidentifiable. However, the proposed framework is able to create a map that is clearly recognizable due to the verifiable high local accuracy and resolution.

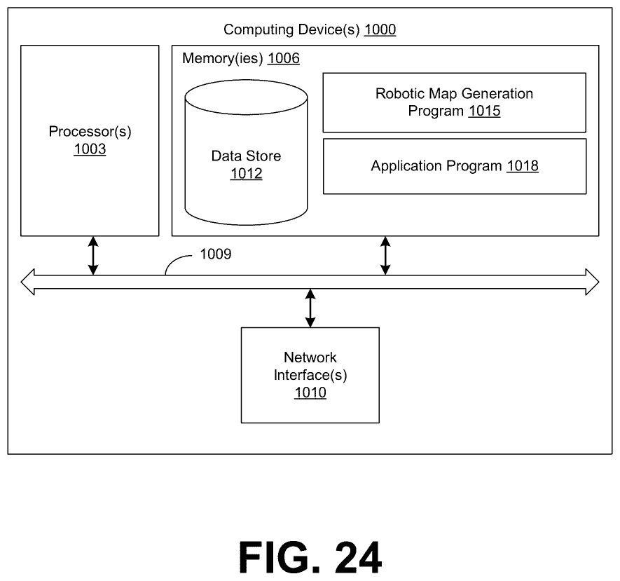

With reference to FIG. 24, shown is a schematic block diagram of a computing (or processing) device 1000 that can be utilized for generating a map of an environment using the described techniques. In some embodiments, among others, the computing device 1000 may represent a mobile device (e.g., a smartphone, tablet, computer, etc.) or other processing device. Each computing device 1000 includes processing circuitry comprising at least one processor circuit, for example, having a processor 1003 and a memory 1006, both of which are coupled to a local interface 1009. To this end, each computing device 1000 may comprise, for example, at least one server computer or like device. The local interface 1009 may comprise, for example, a data bus with an accompanying address/control bus or other bus structure as can be appreciated.

In some embodiments, the computing device 1000 can include one or more network interfaces 1010. The network interface 1010 may comprise, for example, a wireless transmitter, a wireless transceiver, and a wireless receiver. As discussed above, the network interface 1010 can communicate with a robotic device and/or a remote computing device using, e.g., a Bluetooth protocol or other suitable communications protocol. As one skilled in the art can appreciate, other wireless protocols may be used in the various embodiments of the present disclosure.

Stored in the memory 1006 are both data and several components that are executable by the processor 1003. In particular, stored in the memory 1006 and executable by the processor 1003 are robotic map generation program 1015, application program 1018, and potentially other applications. Also stored in the memory 1006 may be a data store 1012 and other data. In addition, an operating system may be stored in the memory 1006 and executable by the processor 1003.

It is understood that there may be other applications that are stored in the memory 1006 and are executable by the processor 1003 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

A number of software components are stored in the memory 1006 and are executable by the processor 1003. In this respect, the term “executable” means a program file that is in a form that can ultimately be run by the processor 1003. Examples of executable programs may be, for example, a compiled program that can be translated into machine code in a format that can be loaded into a random access portion of the memory 1006 and run by the processor 1003, source code that may be expressed in proper format such as object code that is capable of being loaded into a random access portion of the memory 1006 and executed by the processor 1003, or source code that may be interpreted by another executable program to generate instructions in a random access portion of the memory 1006 to be executed by the processor 1003, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, performing load balancing. The processor 1003 may be of electrical or of some other available construction.

Although the robotic map generation program 1015 and the application program 1018, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the robotic map generation program 1015 and the application program 1018, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the robotic map generation program 1015 and the application program 1018, may be implemented and structured in a variety of ways. For example, one or more applications described may be implemented as modules or components of a single application. For example, separate applications can be executed for the viscoelasticity estimation workflows. Further, one or more applications described herein may be executed in shared or separate computing devices or a combination thereof. For example, a plurality of the applications described herein may execute in the same computing device 1000, or in multiple computing devices in the same computing environment. Additionally, it is understood that terms such as “application,” “service,” “system,” “engine,” “module,” and so on may be interchangeable and are not intended to be limiting.

This disclosure has presented a multistage framework for high-precision autonomous robotic map creation and autonomous robotic map refinement approach. Given a map created by a conventional mapping technique, Step 1 plans a suitable path for the robot to revisit the environment while maintaining a desired distance to all objects of interest incorporating UDM and a reduced-order TSP technique. In Step 2, the robot can finalize the map by replanning the path and achieving the targeted resolution and local accuracy. Parametric studies first validated the effectiveness of the proposed Steps 1 and 2, and the autonomous performance of the proposed approach has been then verified through a real-world application. It was found that the steps of the multistage framework are able to improve the results related to the challenges associated with the current mapping efforts. The pose and scan accuracy were validated for the proposed framework with parametric studies testing the planning and execution performance. The final practical experiment validated the autonomous capabilities of the proposed framework through testing in different types of environments. The performance of the framework was not hindered in any off the environments, thereby confirming the practical usefulness of the framework.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially. The term “about,” as used herein, means approximately, in the region of, roughly, or around. When the term “about is used in conjunction with a numerical range, it modifies the range by extending the boundaries above and below the numerical values set forth. In general, the term “about” is used herein to modify a numerical value above and below the stated value by a variance of 10%.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A method for generating a map of an environment, comprising:
obtaining a coarse global mapping of an environmental space;
determining a robotic traversal path within the environmental space based at least in part upon the coarse global mapping, the robotic traversal path maintaining a targeted distance to a nearest structure within the environmental space;
initiating traversal of a robot along the determined robotic traversal path, the robot configured to obtain depth sensor measurements of the nearest structure during traversal along the determined robotic traversal path; and
refining the robotic traversal path during traversal by the robot along the determined robotic traversal path based upon the depth sensor measurements, where the robotic traversal path is refined online to achieve targeted resolution and local accuracy of the depth sensor measurements.

2. The method of claim 1, comprising generating a refined map of the environmental space based at least in part upon the depth sensor measurements.

3. The method of claim 1, wherein the coarse global mapping is a three-dimensional (3D) globally accurate mapping obtained by the robot.

4. The method of claim 3, wherein the coarse global mapping is obtained via a LIDAR scan.

5. The method of claim 1, wherein the targeted distance is associated with the targeted resolution and local accuracy.

6. The method of claim 5, comprising determining the targeted distance such that a sum of a difference between a predicted resolution and the targeted resolution and a difference between a predicted local accuracy and the targeted local accuracy is smallest.

7. The method of claim 1, wherein the robotic traversal path is a three-dimensional (3D) robotic traversal path within the environmental space.

8. The method of claim 6, wherein determining the robotic traversal path within the environmental space comprises:
determining an occupancy grid map (OGM), in which each grid has information indicating whether corresponding space is occupied or not, at a plurality of heights in the environmental space;
determining an unoccupancy distance map (UDM), in which each pixel has a distance to a nearest occupied grid, for each OGM of the plurality of heights;
determining a two-dimensional (2D) path at each of the plurality of heights based upon the targeted distance; and
connecting the 2D paths to produce the 3D robotic traversal path.

9. The method of claim 8, wherein determining the 2D path at each of the plurality of heights comprises:
selecting a pixel in UDM having the targeted distance; and
connecting the selected pixels.

10. The method of claim 8, wherein the 2D paths are connected for robot traversal of the 3D path in a single loop.

11. The method of claim 1, wherein refining the robotic traversal path is based upon pixel density of the depth sensor measurements.

12. The method of claim 11, wherein the depth sensor measurements are obtained via RGB-D camera measurements.

13. The method of claim 1, wherein refining the robotic traversal path comprises determining an incremental motion of the robot so as to minimize a difference between a desired robot pose at a next time step and a current robot pose under a constraint that a predicted pixel density is the desired pixel density and a predicted local accuracy is the desired local accuracy.

14. The method of claim 1, wherein the coarse global mapping comprises a globally accurate point cloud and refining the robotic traversal path comprises refining the globally accurate point cloud by registering point cloud data of the depth sensor measurements to the globally accurate point cloud.

15. A system for generating a map of an environment, comprising:
a robot configured to obtain depth sensor measurements; and
at least one computing device in communication with the robot, the at least one computing device configured to:
determine a robotic traversal path within an environmental space based at least in part upon a coarse global mapping of the environmental space, the robotic traversal path maintaining a targeted distance to a nearest structure within the environmental space;
initiate traversal of the robot along the determined robotic traversal path, the robot configured to obtain depth sensor measurements of the nearest structure during traversal along the determined robotic traversal path; and
refine the robotic traversal path during traversal by the robot along the determined robotic traversal path based upon the depth sensor measurements,
where the robotic traversal path is refined online to achieve targeted resolution and local accuracy of the depth sensor measurements.

16. The system of claim 15, wherein the coarse global mapping is a three-dimensional (3D) globally accurate mapping obtained by the robot.

17. The system of claim 16, wherein the robot obtains the coarse global mapping via a LIDAR scan.

18. The system of claim 15, wherein the robotic traversal path is a three-dimensional (3D) robotic traversal path within the environmental space.

19. The system of claim 18, wherein determining, by the at least one computing device, the robotic traversal path within the environmental space comprises:
determining an occupancy grid map (OGM), in which each grid has information indicating whether corresponding space is occupied or not, at a plurality of heights in the environmental space;
determining an unoccupancy distance map (UDM), in which each pixel has a distance to a nearest occupied grid, for each OGM of the plurality of heights;
determining a two-dimensional (2D) path at each of the plurality of heights based upon the targeted distance; and
connecting the 2D paths to produce the 3D robotic traversal path.

20. The system of claim 19, wherein the 2D paths are connected for robot traversal of the 3D path in a single loop.

21. The system of claim 15, wherein the robotic traversal path is refined by the at least one computing device based upon pixel density of the depth sensor measurements obtained by the robot.

22. The system of claim 21, wherein the robot comprises an RGB-D camera configured to obtain the depth sensor measurements.

23. The system of claim 15, wherein the coarse global mapping comprises a globally accurate point cloud and the at least one computing device generates a refined map of the environmental space by registering point cloud data of the depth sensor measurements to the globally accurate point cloud.
